(19) United States
(12) Patent Application Publication
(10) Pub. No.: US 2009/0175411 A1
(43) Pub. Date: Jul. 9, 2009

(54) Methods and systems for use in security screening, with parallel processing capability

(76) Inventors: Dan Gudmundson, Quebec (CA); Michel Bouchard, Saint-Augustin-de-Desmaures (CA); Martin Lacasse, Levis (CA); Adlene Sifi, Quebec (CA); Luc Perron, Charlesbourg (CA)

Correspondence Address: Ralph A. Dowell of DOWELL & DOWELL P.C., 2111 Eisenhower Ave, Suite 406, Alexandria, VA, 22314, US

(21) Appl. No.: 12/227,526

(22) PCT Filed: Jul. 20, 2007
(86) PCT No.: PCT/CA2007/001298

§ 371 Date: Nov. 20, 2008

Related U.S. Application Data
(60) Provisional application No. 60/807,882, filed on Jul. 20, 2006.

(30) Foreign Application Priority Data
Mar. 30, 2007 (US) 11/694338

(51) Int. Cl. G01N 23/04

(52) U.S. Cl. 378/57

(57) ABSTRACT

A security screening system to determine if an item of luggage carries an object posing a security threat. The security screening system may comprise an input for receiving image data derived from an apparatus that subjects the item of luggage to penetrating radiation, the image data conveying an image of the item of luggage. The security screening system may also comprise a processing module for processing the image data to identify in the image a plurality of regions of interest, the regions of interest manifesting a higher probability of depicting an object posing a security threat than portions of the image outside the regions of interest. The processing module may comprise: a first processing entity for processing a first one of the regions of interest to ascertain if the first region of interest depicts an object posing a security threat; and a second processing entity for processing a second one of the regions of interest to ascertain if the second region of interest depicts an object posing a security threat. The processing of the first and second regions of interest by the first and second processing entity occurs in parallel. Different processing entities may also be used to process in parallel different sets of entries a reference database to determine if an item of luggage carries an object posing a security threat.

### CROSS-REFERENCE TO RELATED APPLICATIONS

This application claims the benefit under 35 USC 119(e) of U.S. Provisional Patent Application No. 60/807,882 filed on Jul. 20, 2006 and hereby incorporated by reference herein. This application is also a continuation-in-part of, and claims the benefit under 35 USC 120, of U.S. patent application Ser. No. 11/694,338 filed on Mar. 30, 2007 and hereby incorporated by reference herein.

### FIELD OF THE INVENTION

The present invention relates generally to security screening systems and, more particularly, to methods and systems for use in security screening, with parallel processing capability.

### BACKGROUND

Security in airports, train stations, ports, mail sorting facilities, office buildings and other public or private venues is becoming increasingly important in particular in light of recent violent events.

For example, security screening systems at airports typically make use of devices generating penetrating radiation, such as x-ray devices, to scan individual items of luggage to generate an image conveying contents of the item of luggage. The image is displayed on a screen and is examined by a human operator whose task it is to identify, on a basis of the image, potentially threatening objects located in the luggage.

A deficiency with current systems is that they are mainly reliant on the human operator to identify potentially threatening objects. However, the human operator's performance greatly varies according to such factors as poor training and fatigue. As such, the process of detection and identification of threatening objects is highly susceptible to human error. Another deficiency is that images displayed on the x-ray machines provide little, if any, guidance as to what is being observed. It will be appreciated that failure to identify a threatening object, such as a weapon for example, may have serious consequences, such as property damage, injuries and human deaths.

Consequently, there is a need for providing improved security screening systems for use at airports, train stations, ports, mail sorting facilities, office buildings and other public or private venues.

### SUMMARY OF THE INVENTION

As broadly described herein, the present invention provides a security screening system to determine if an item of luggage carries an object posing a security threat. The security screening system comprises an input for receiving image data derived from an apparatus that subjects the item of luggage to penetrating radiation, the image data conveying an image of the item of luggage. The security screening system also comprises a processing module for processing the image data to identify in the image a plurality of regions of interest, the regions of interest manifesting a higher probability of depicting an object posing a security threat than portions of the image outside the regions of interest. The processing module comprises: a first processing entity for processing a first one of the regions of interest to ascertain if the first region of interest depicts an object posing a security threat; and a second processing entity for processing a second one of the regions of interest to ascertain if the second region of interest depicts an object posing a security threat. The processing of the first and second regions of interest by the first and second processing entity occurs in parallel.

The present invention also provides a method for performing a security screening on an item of luggage. The method comprises: subjecting the item of luggage to penetrating radiation to generate image data that conveys an image of the item of luggage; processing the image data to identify a plurality of regions of interest within the image that manifest a higher probability of depicting an object posing a security threat than portions of the image outside the regions of interest; and initiating a plurality of parallel processing threads by respective parallel processing entities, each processing thread processing image data from the regions of interest, wherein each processing thread searches the image data it processes to ascertain if it depicts an object posing a security threat.

The present invention also provides a security screening system to determine if an item of luggage carries an object posing a security threat. The security screening system comprises an input for receiving image data derived from an apparatus that subjects the item of luggage to penetrating radiation, the image data conveying an image of the item of luggage. The security screening system also comprises a database containing a plurality of entries, each entry including a representation of an object posing a security threat. The security screening system also comprises a processing module for processing the image data to determine if the image depicts an object posing a security threat from the database. The processing module comprises: a first processing entity for processing image data against a first set of entries from the database to determine if the image data depicts an object posing a security threat represented by any entry of the first set of entries; and a second processing entity for processing image data against a second set of entries from the database to determine if the image data depicts an object posing a security threat represented by any entry of the second set of entries. The first set of entries is different from the second set of entries and the processing of the first and second processors occurs in parallel.

The present invention also provides a method for performing a security screening on an item of luggage. The method comprises: receiving image data derived from an apparatus that subjects the item of luggage to penetrating radiation, the image data conveying an image of the item of luggage; having access to a database containing a plurality of entries, each entry including a representation of an object posing a security threat; processing image data against a first set of entries from the database using a first processing entity to determine if the image data depicts an object posing a security threat represented by any entry of the first set of entries; and processing image data against a second set of entries from the database using a second processing entity to determine if the image data depicts an object posing a security threat represented by any entry of the first set of entries; wherein the first set of entries is different from the second set of entries and the processing using the first and second processing entities occurs in parallel.

Other aspects and features of the present invention will become apparent to those ordinarily skilled in the art upon review of the following description of embodiments of the present invention in conjunction with the accompanying figures.

### BRIEF DESCRIPTION OF THE DRAWINGS

A detailed description of embodiments of the present invention is provided herein below, by way of example only, with reference to the accompanying drawings, in which:

FIG. 1 shows a system for security screening of receptacles, in accordance with an embodiment of the present invention;

FIG. 2 shows a processing system of the system shown in FIG. 1, in accordance with an embodiment of the present invention;

FIG. 3 shows a display control module of the processing system shown in FIG. 2, in accordance with an embodiment of the present invention;

FIG. 4 shows an example of a process implemented by the display control module shown in FIG. 3, in accordance with an embodiment of the present invention;

FIGS. 5A, 5B and 5C show examples of manifestations of a graphical user interface implemented by the display control module of FIG. 3 at different times, in accordance in accordance with an embodiment of the present invention;

FIG. 6 shows a control window of the graphical user interface implemented by the display control module of FIG. 3 for allowing a user to configure screening options, in accordance in accordance with an embodiment of the present invention;

FIG. 7 shows an example of a process for facilitating visual identification of threats in images associated with previously screened receptacles, in accordance in accordance with an embodiment of the present invention;

FIG. 8 shows an automated threat detection processing module of the processing system shown in FIG. 2, in accordance with an embodiment of the present invention;

FIGS. 9A and 9B show an example of a process implemented by the automated threat detection processing module shown in FIG. 8, in accordance with an embodiment of the present invention;

FIG. 10 is a block diagram of an apparatus suitable for implementing functionality of components of the system shown in FIG. 1, in accordance with an embodiment of the present invention;

FIG. 11 is a block diagram of another apparatus suitable for implementing functionality of components of the system shown in FIG. 1, in accordance with an embodiment of the present invention;

FIG. 12 shows a block diagram of a client-server system suitable for implementing a system such as the system shown in FIG. 1 in a distributed manner, in accordance with an embodiment of the present invention;

FIGS. 13A and 13B depict a first example of an original image conveying contents of a receptacle and a corresponding enhanced image, in accordance with an embodiment of the present invention;

FIGS. 13C and 13D depict a second example of an original image conveying contents of a receptacle and a corresponding enhanced image, in accordance with an embodiment of the present invention;

FIGS. 13E, 13F and 13G depict a third example of an original image conveying contents of a receptacle and two (2) corresponding enhanced images, in accordance with an embodiment of the present invention;

FIG. 14 is a graphical illustration of a process implemented by the automated threat detection processing module shown in FIG. 8 in accordance with an alternative embodiment of the present invention;

FIG. 15 shows an example of potential contents of a reference database of the processing system shown in FIG. 2, in accordance with an embodiment of the present invention;

FIG. 16 shows an example of a set of images of contours of a threat-posing object in different orientations;

FIG. 17 shows a parallel processing architecture implemented by the processing system shown in FIG. 2, in accordance with an embodiment of the present invention;

FIG. 18A illustrates an example where different processing entities of the processing system shown in FIG. 17 process in parallel different regions of interest of an image of contents of a receptacle; and

FIG. 18B illustrates an example where different processing entities of the processing system shown in FIG. 17 process in parallel different sets of entries in the reference database shown in FIG. 15.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

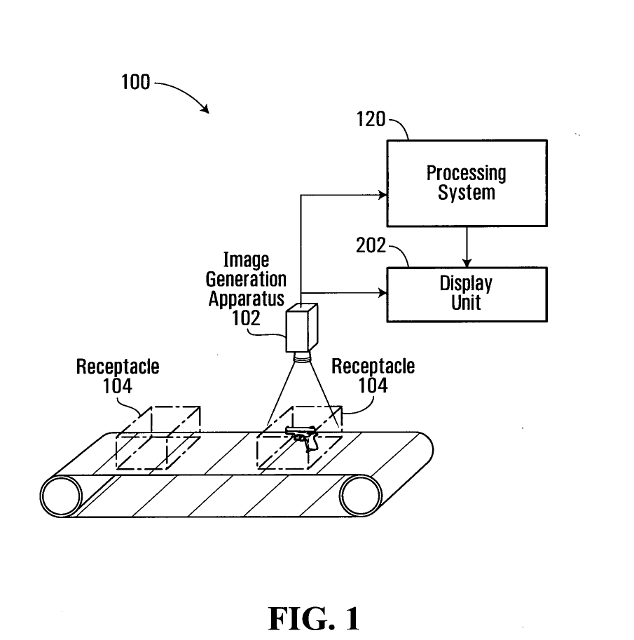

FIG. 1 shows a system 100 for security screening of receptacles in accordance with an embodiment of the present invention. A “receptacle”, as used herein, refers to an entity adapted for receiving and carrying objects therein such as, for example, an item of luggage, a cargo container, or a mail parcel. For its part, an “item of luggage”, as used herein, refers to a suitcase, a handbag, a backpack, a briefcase, a box, a parcel or any other similar type of item suitable for receiving and carrying objects therein.

In this embodiment, the system 100 comprises an image generation apparatus 102, a display unit 202, and a processing system 120 in communication with the image generation apparatus 102 and the display unit 202.

As described in further detail below, the image generation apparatus 102 is adapted for scanning a receptacle 104 to generate image data conveying an image of contents of the receptacle 104. The processing system 120 is adapted to process the image data in an attempt to detect presence of one or more threat-posing objects which may be contained in the receptacle 104. A “threat-posing object” refers to an object that poses a security threat and that the processing system 120 is designed to detect. For example, a threat-posing object may be a prohibited object such as a weapon (e.g., a gun, a knife, an explosive device, etc.). A threat-posing object may not be prohibited but still pose a potential threat. For instance, in embodiments where the system 100 is used for luggage security screening, a threat-posing object may be a metal plate or a metal canister in an item of luggage that, although not necessarily prohibited in itself, may conceal one or more objects which may pose a security threat. As such, it is desirable to be able to detect presence of such threat-posing objects which may not necessarily be prohibited in order to bring them to the attention of a user (i.e., a security screener) of the system 100. More particularly, in this embodiment, the processing system 120 is adapted to process the image data conveying the image of contents of the receptacle 104 to identify one or more “regions of interest” of the image. Each region of interest is a region of the image that manifests a higher probability of depicting a threat-posing object than portions of the image outside that region of interest. The processing system 120 is operative to cause the display unit 202 to display information conveying the one or more regions of interest of the image, while it processes image data corresponding to these one or more regions of interest to derive threat information regarding the receptacle 104. The threat information regarding the receptacle 104 can be any information regarding a threat potentially posed by one or more objects contained in the receptacle 104. For example, the threat information may indicate that one or more threat-posing objects are deemed to be present in the receptacle 104. In some cases, the threat information may identify each of the one or more threat-posing objects deemed to be present in the receptacle 104. As another example, the threat information may indicate a level of confidence that the receptacle 104 represents a threat. As yet another example, the threat information may indicate a level of threat (e.g., low, medium or high; or a percentage) represented by the receptacle 104.

In this embodiment, the processing system 120 derives the threat information regarding the receptacle 104 by processing the image data corresponding to the one or more regions of interest of the image in combination with a plurality of data elements associated with a plurality of threat-posing objects that are to be detected. The data elements associated with the plurality of threat-posing objects to be detected are stored in a reference database, an example of which is provided later on.

Also, in accordance with an embodiment of the present invention, the processing system 120 implements a parallel processing architecture that enables parallel processing of data in order to improve efficiency of the system 100. As discussed later on, in this embodiment, in cases where the processing system 120 processes the image data conveying the image of contents of the receptacle 104 and identifies a plurality of regions of interest of the image, the parallel processing architecture allows the processing system 120 to process in parallel these plural regions of interest of the image. Alternatively or in addition, the parallel processing architecture may allow the processing system 120 to process in parallel a plurality of sets of entries in the aforementioned reference database. This parallel processing capability of the processing system 120 allows processing times to remain relatively small for practical implementations of the system 100 where processing speed is an important factor. This is particularly beneficial, for instance, in cases where the system 100 is used for security screening of items of luggage where screening time is a major consideration.

Once it has derived the threat information regarding the receptacle 104, the processing system 120 is operative to cause the display unit 202 to display the threat information. Since the information conveying the one or more regions of interest of the image is displayed on the display unit 202 while the threat information is being derived by the processing system 120, the threat information is displayed on the display unit 202 subsequent to initial display on the display unit 202 of the information conveying the one or more regions of interest of the image.

Thus, in this embodiment, the system 100 makes use of multiple processing operations in order to provide to a user information for facilitating visual identification of potential threats posed by objects in the receptacle 104. More specifically, the system 100 operates by first making use of information intrinsic to the image of contents of the receptacle 104 in order to identify one or more regions of interest in the image. Since this information is not dependent upon the size of the aforementioned reference database, the information is typically generated relatively quickly and is then displayed to the user on the display unit 202. The system 100 then makes use of the identified one or more regions of interest of the image to perform in-depth image processing which, in this case, involves processing data elements stored in the aforementioned reference database in an attempt to detect representation of one or more threat-posing objects in the one or more regions of interest. Once the image processing has been completed, threat information regarding the receptacle 104 can then be displayed to the user on the display unit 202.

One advantage is that the system 100 provides to the user interim screening results that can guide the user in visually identifying potential threats in the receptacle 104. More particularly, the information conveying the one or more regions of interest that is displayed on the display unit 202 attracts the user's attention to one or more specific areas of the image so that the user can perform a visual examination of that image focusing on these specific areas. While the user performs this visual examination, the data corresponding to the one or more regions of interest is processed by the processing system 120 to derive threat information regarding the receptacle 104. The threat information is then displayed to the user. In this fashion, information is incrementally provided to the user for facilitating visual identification of a threat in an image displayed on the display unit 202. By providing interim screening results to the user, in the form of information conveying one or more regions of interest of the image, prior to completion of the image processing to derive the threat information regarding the receptacle 104, the responsiveness of the system 100 as perceived by the user is increased.

Examples of how the information conveying the one or more regions of interest of the image and the threat information regarding the receptacle 104 can be derived are described later on.

Image Generation Apparatus 102

In this embodiment, the image generation apparatus 102 subjects the receptacle 104 to penetrating radiation to generate the image data conveying the image of contents of the receptacle 104. Examples of suitable devices that may be used to implement the image generation apparatus 102 include, without being limited to, x-ray, gamma ray, computed tomography (CT), thermal imaging, TeraHertz and millimeter wave devices. Such devices are well known and as such will not be described further here. In this example, the image generation apparatus 102 is a conventional x-ray machine suitable for generating data conveying an x-ray image of the receptacle 104. The x-ray image conveys, amongst others, material density information related to objects present in the receptacle 104.

The image data generated by the image generation apparatus 102 and conveying the image of contents of the receptacle 104 may convey a two-dimensional (2-D) image or a three-dimensional (3-D) image and may be in any suitable format such as, for example, VGA, SVGA, XGA, JPEG, GIF, TIFF, and bitmap, amongst others. The image data conveying the image of contents of the receptacle 104 may be in a format that allows the image to be displayed on a display screen (e.g., of the display unit 202).

In some embodiments (e.g., where the receptacle 104 is large, as is the case with a cargo container), the image generation apparatus 102 may be configured to scan the receptacle 104 along various axes to generate image data conveying multiple images of contents of the receptacle 104. Scanning methods for large objects are known and as such will not be described further here. Each of the multiple images may then be processed in accordance with principles described herein to detect presence of one or more threat-posing objects in the receptacle 104.

Display Unit 202

The display unit 202 may comprise any device adapted for conveying information in visual format to the user of the system 100. In this embodiment, the display unit 202 is in communication with the processing system 120 and includes a display screen adapted for displaying information in visual format and pertaining to screening of the receptacle 104. The display unit 202 may be part of a stationary computing system or may be part of a portable device (e.g., a portable computer, including a handheld computing device). Depending on its implementation, the display unit 202 may be in communication with the processing system 120 via any suitable communication link, which may include a wired portion, a wireless portion, or both.

In some embodiments, the display unit 202 may comprise a printer adapted for displaying information in printed format. It will be appreciated that the display unit 202 may comprise other components in other embodiments.

Processing System 120

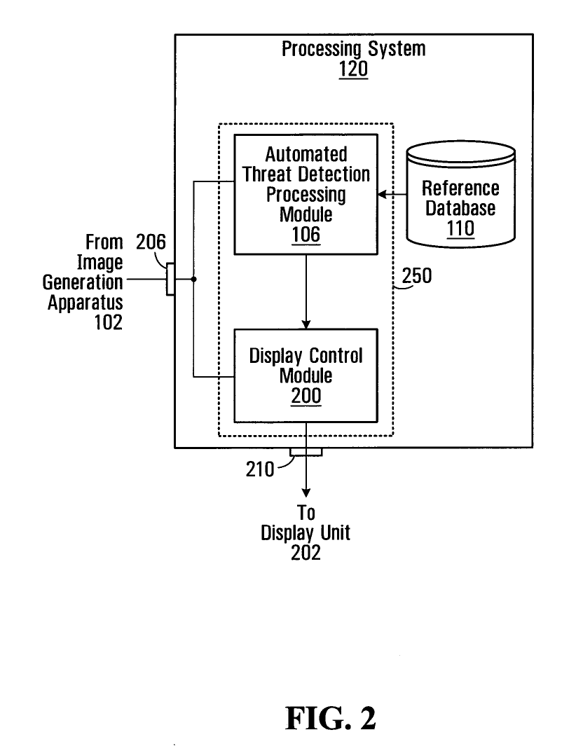

FIG. 2 shows an embodiment of the processing system 120. In this embodiment, the processing system 120 comprises an input 206, an output 210, and a processing unit 250 in communication with the input 206 and the output 210.

The input 206 is for receiving the image data conveying the image of contents of the receptacle 104 that is derived from the image generation apparatus 102.

The output 210 is for releasing signals to cause the display unit 202 to display information for facilitating visual identification of a threat in the image of contents of the receptacle 104 conveyed by the image data received at the input 206.

The processing unit 250 is adapted to process the image data conveying the image of contents of the receptacle 104 that is received at the input 206 to identify one or more regions of interest of the image. The processing unit 250 is operative to release signals via the output 210 to cause the display unit 202 to display information conveying the one or more regions of interest of the image.

Meanwhile, the processing unit 250 processes the one or more regions of interest (i.e., image data corresponding to the one or more regions of interest) to derive threat information regarding the receptacle 104. In this embodiment, the processing unit 250 derives the threat information regarding the receptacle 104 by processing the one or more regions of interest of the image in combination with a plurality of data elements associated with a plurality of threat-posing objects that are to be detected. The data elements associated with the plurality of threat-posing objects are stored in a reference database 110 accessible to the processing unit 250. An example of potential contents of the reference database 110 is provided later on.

In accordance with an embodiment of the present invention, the processing unit 250 implements a parallel processing architecture that enables parallel processing of data in order to improve efficiency of the system 100. Further detail regarding this parallel processing capability of the processing unit 250 is described later on.

Once it has derived the threat information regarding the receptacle 104, the processing unit 250 is operative to release signals via the output 210 to cause the display unit 202 to display the threat information.

More particularly, in this embodiment, the processing unit 250 comprises an automated threat detection processing module 106 and a display control module 200.

The automated threat detection processing module 106 receives the image data conveying the image of contents of the receptacle 104 via the input 206 and processes that data to identify one or more regions of interest of the image. The automated threat detection processing module 106 then releases to the display control module 200 data conveying the one or more regions of interest of the image. Based on this data, the display control module 200 causes the display unit 202 to display information conveying the one or more regions of interest of the image for viewing by the user. Meanwhile, the automated threat detection processing module 106 processes the one or more regions of interest of the image to derive threat information regarding the receptacle 104. As mentioned above, the threat information regarding the receptacle 104 can be any information regarding a threat potentially represented by one or more objects contained in the receptacle 104. For example, the threat information may indicate that one or more threat-posing objects are deemed to be present in the receptacle 104. In some cases, the threat information may identify each of the one or more threat-posing objects. As another example, the threat information may indicate a level of confidence that the receptacle 104 contains one or more objects that represent a threat. As yet another example, the threat information may indicate a level of threat (e.g., low, medium or high; or a percentage) represented by the receptacle 104. In other examples, the threat information may include various other information elements. Upon deriving the threat information regarding the receptacle 104, the automated threat detection processing module 106 releases it to the display control module 200, which proceeds to cause the display unit 202 to display the threat information for viewing by the user. An example of implementation of the automated threat detection processing module 106 is described later on.

Display Control Module 200

In this embodiment, the display control module 200 implements a graphical user interface for conveying information to the user via the display unit 202. An example of the graphical user interface is described later on. The display control module 200 receives from the automated threat detection processing module 106 the data conveying the one or more regions of interest of the image. The display control module 200 also receives the image data conveying the image of contents of the receptacle 104 derived from the image generation apparatus 102. Based on this data, the display control module 200 generates and releases via the output 210 signals for causing the display unit 202 to display information conveying the one or more regions of interest of the image. The display control module 200 also receives the threat information released by the automated threat detection processing module 106 and proceeds to generate and release via the output 210 signals for causing the display unit 202 to display the threat information.

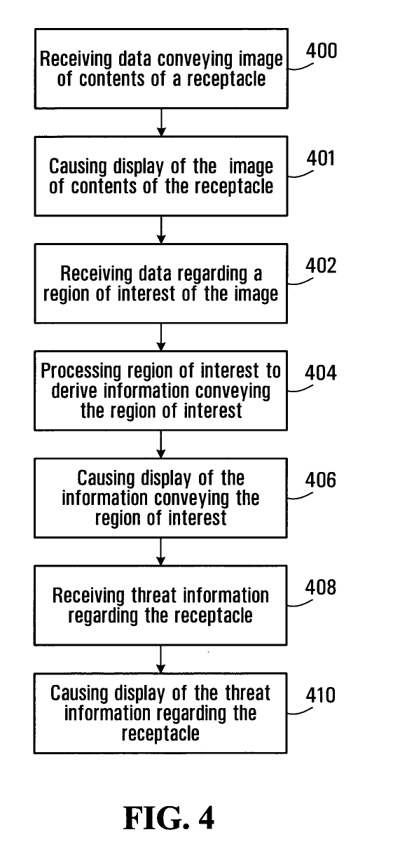

An example of a method implemented by the display control module 200 will now be described with reference to FIG. 4.

At step 400, the display control module 200 receives from the image generation apparatus 102 the image data conveying the image of contents of the receptacle 104.

At step 401, the display control module 200 causes the display unit 202 to display the image of contents of the receptacle 104 based on the image data received at step 400.

At step 402, the display control module 200 receives from the automated threat detection processing module 106 the data conveying the one or more regions of interest in the image. For purposes of this example, it is assume that the automated threat detection processing module 106 identified one region of interest of the image and thus that the data received by the display control module 200 conveys that region of interest. The data received from the automated threat detection processing module 106 may include location information regarding a location in the image of contents of the receptacle.

In one embodiment, the location information may include an (X,Y) pixel location indicating the center of an area in the image. The region of interest is established based on the pixel location (X,Y) provided by the automated threat detection processing module 106 in combination with a shape for the area. The shape of the area may be pre-determined, in which case it may be of any suitable geometric shape and have any suitable size. Alternatively, the shape and/or size of the region of interest may be determined by the user on a basis of a user configuration command.

In another embodiment, the shape and/or size of the region of interest is determined on a basis of data provided by the automated threat detection processing module 106. For example, the data may include a plurality of (X,Y) pixel locations defining an area in the image of contents of the receptacle 104. In such a case, the data received from the automated threat detection processing module 106 may specify both the position of the region of interest in the image and the shape of the region of interest.

In yet another embodiment, the automated threat detection processing module 106 may provide an indication of a type of threat-posing object potentially identified in the receptacle 104 being screened in addition to a location of that threat-posing object in the image. Based on this information, a region of interest having a shape and size conditioned on a basis of the potentially identified threat-posing object may be determined.

At step 404, the data conveying the region of interest of the image received at step 402 is processed to derive information conveying the region of interest. In this embodiment, the information conveying the region of interest is in the form of an enhanced image of contents of the receptacle 104. The enhanced image conveys the region of interest in a visually contrasting manner relative to portions of the image outside the region of interest. The enhanced image is such that portions outside the region of interest are visually de-emphasized and/or is such that features appearing inside the region of interest are visually emphasized. Many different methods for visually emphasizing the region of interest of the image received at step 400 may be employed. Examples of such methods include, without being limited to, highlighting the region of interest, overlaying a graphical representation of a boundary surrounding the region of interest, and applying image manipulation techniques for emphasizing features appearing inside the region of interest and/or de-emphasizing features appearing outside the region of interest. Hence, in this embodiment, at step 404, the data conveying the image of contents of the receptacle 104 received at step 400 is processed based on the data indicating the region of interest received at step 402 to generate the information conveying the region of interest in the form of an enhanced image.

Although in this embodiment the information conveying the region of interest is in the form of an enhanced image, it will be appreciated that the information conveying the region of interest of the image may take on various other forms in other embodiments. For example, the information conveying the region of interest of the image may be in the form of an arrow or other graphical element displayed in combination with the image of contents of the receptacle 104 so as to highlight the location of the region of interest.

At step 406, the display control module 200 causes the display unit 202 to display the information conveying the region of interest of the image derived at step 404.

At step 408, the display control module 200 receives from the automated threat detection processing module 106 threat information regarding the receptacle 104 being screened. The threat information regarding the receptacle 104 can be any information regarding a threat potentially represented by one or more objects contained in the receptacle 104. For example, the threat information may indicate that one or more threat-posing objects are deemed to be present in the receptacle 104. In some cases, the threat information may identify each of the one or more threat-posing objects. As another example, the threat information may indicate a level of confidence that the receptacle 104 contains one or more objects that represent a threat. As yet another example, the threat information may indicate a level of threat (e.g., low, medium or high; or a percentage) represented by the receptacle 104. In other examples, the threat information may include various other information elements.

At step 410, the display control module 200 causes the display unit 202 to display the threat information regarding the receptacle 104 received at step 408.

It will be appreciated that, in some embodiments, the display control module 200 may receive from the automated threat detection processing module 106 additional threat information regarding the receptacle 104 subsequently to the threat information received at step 408. As such, in these embodiments, steps 408 and 410 may be repeated for each additional threat information received by the display control module 200 from the automated threat detection processing module 106.

It will also be appreciated that, while in this example it is assumed that the automated threat detection processing module 106 identified one region of interest of the image, in examples where the automated threat detection processing module 106 identifies plural regions of interest of the image and the display control module 200, the threat information may be received for each identified region of interest. In such examples, steps 408 and 410 may be repeated for each region of interest identified by the automated threat detection processing module 106.

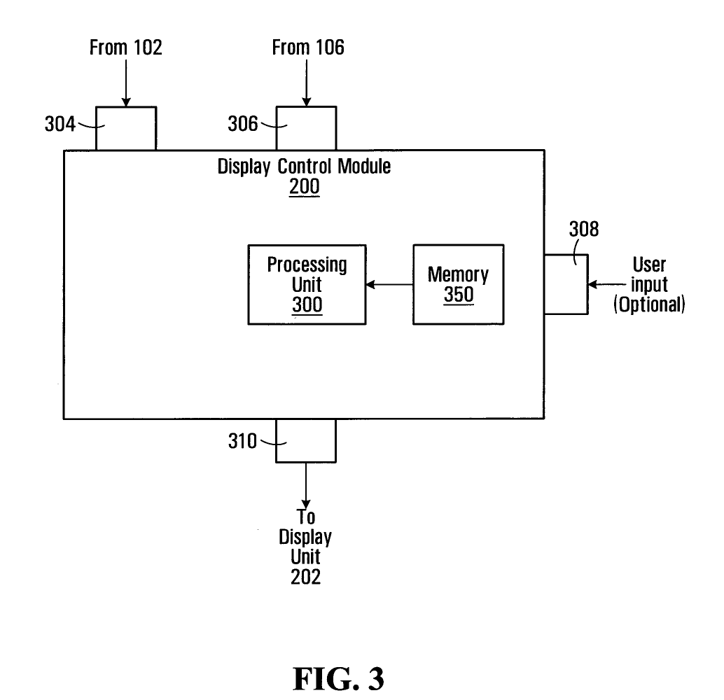

Turning now to FIG. 3, there is shown an embodiment of the display control module 200 for implementing the above-described process. In this embodiment, the display control module 200 includes a first input 304, a second input 306, a processing unit 300, an output 310, and optionally a user input 308.

The first input 304 is for receiving the image data conveying the image of contents of the receptacle 104 derived from the image generation apparatus 102.

The second input 306 is for receiving information from the automated threat detection processing module 106. As described above, this includes the data conveying the one or more regions of interest in the image identified by the automated threat detection processing module 106 as well as the threat information regarding the receptacle 104 derived by the automated threat detection processing module 106.

The user input 308, which is optional, is for receiving signals from a user input device, the signals conveying commands from the user, such as commands for controlling information displayed by the user interface module implemented by the display control module 200 or for annotating the information displayed. Any suitable user input device for inputting commands may be used such as, for example, a mouse, keyboard, pointing device, speech recognition unit or touch sensitive screen.

The processing unit 300 is in communication with the first input 304, the second input 306 and the user input 308 and implements the user interface module for facilitating visual identification of a threat in the image of contents of the receptacle 104. More specifically, the processing unit 300 is adapted for implementing the process described above in connection with FIG. 4, including releasing signals at the output 310 for causing the display unit 202 to display the information conveying the one or more regions of interest of the image and the threat information regarding the receptacle 104.

For purposes of illustration, an example of implementation where the information conveying the region of interest of the image is in the form of an enhanced image of contents of the receptacle 104 will now be described.

In this example, the processing unit 300 is operative for processing the image of contents of the receptacle 104 received at the first input 304 to generate an enhanced image based at least in part on the information received at the second input 306 and optionally on commands received at the user input 308. In one embodiment, the processing unit 300 is adapted for generating an image mask on a basis of the information received at the second input 306 indicating a region of interest of the image. The image mask includes a first enhancement area corresponding to the region of interest and a second enhancement area corresponding to portions of the image outside the region of interest. The image mask allows application of a different type of image enhancement processing to portions of the image corresponding to the first enhancement area and the second enhancement area in order to generate the enhanced image.

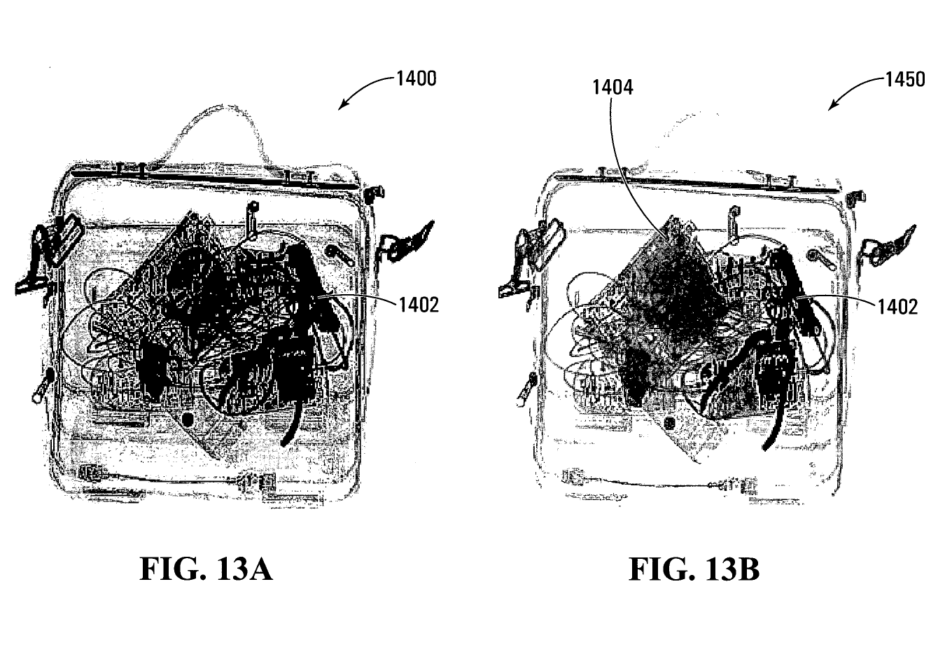

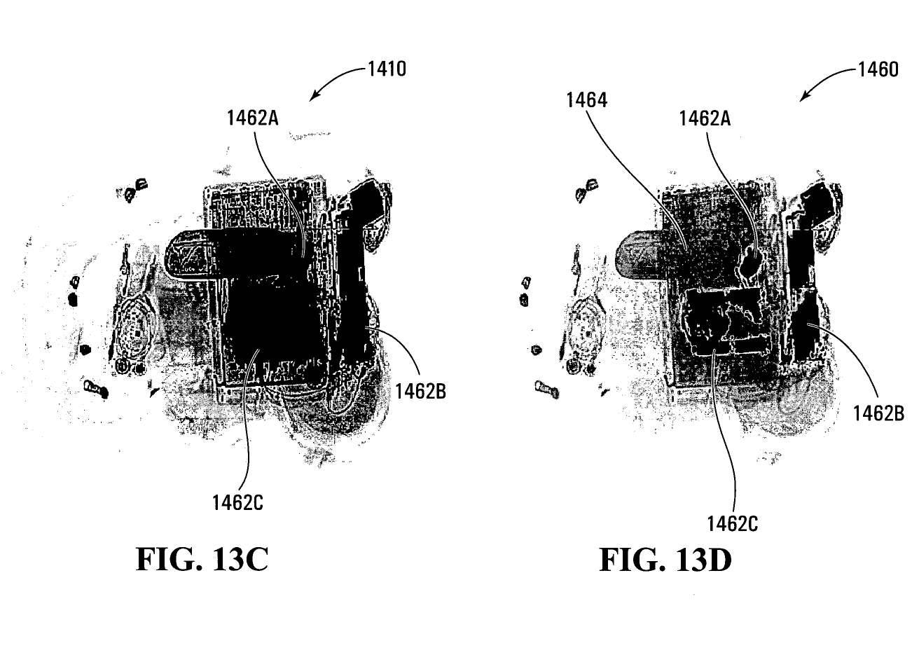

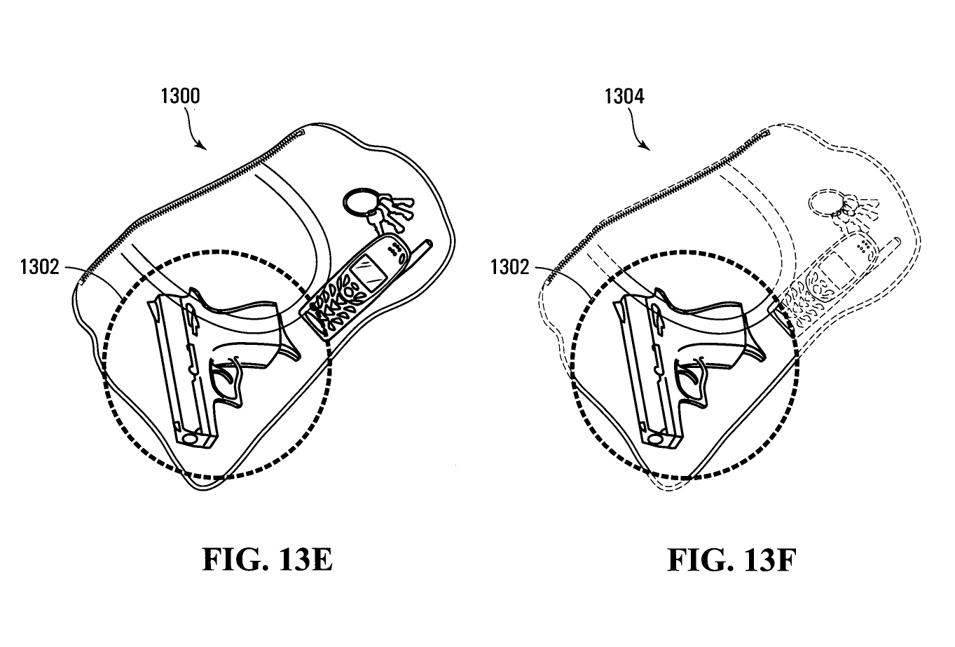

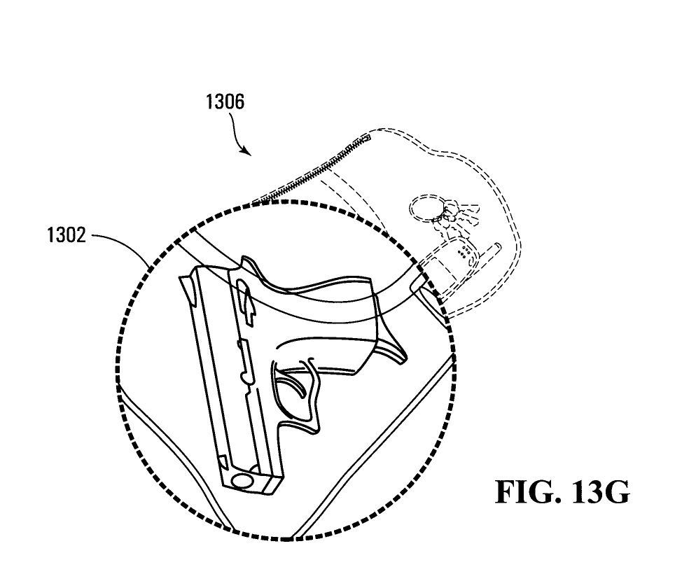

FIGS. 13a to 13g depict various illustrative examples of images and corresponding enhanced images that may be generated by the processing unit 300 in various possible embodiments.

More particularly, FIG. 13a depicts a first exemplary image 1400 conveying contents of a receptacle that was generated by an x-ray machine. The processing unit 300 processes the first exemplary image 1400 to derive information conveying a region of interest, denoted as 1402 in FIG. 13a. FIG. 13b depicts an enhanced version of the image of FIG. 13a, which is referred to as an enhanced image 1450, resulting from application of an image mask that includes an enhanced area corresponding to the region of interest 1402. In this example, the enhanced image 1450 is such that portions 1404 of the image which lie outside the region of interest 1402 have been visually de-emphasized and features appearing inside the region of interest 1402 have been visually emphasized.

FIG. 13c depicts a second exemplary image 1410 conveying contents of another receptacle that was generated by an x-ray machine. The processing unit 300 processes the second exemplary image 1410 to derive information conveying a plurality of regions of interest, respectively denoted as 1462a, 1462b and 1462c in FIG. 13c. FIG. 13d depicts an enhanced version of the image of FIG. 13c, which is referred to as an enhanced image 1460. In this example, the enhanced image 1460 is such that portions 1464 of the image which lie outside the regions of interest 1462a, 1462b and 1462c have been visually de-emphasized and features appearing inside the regions of interest 1462a, 1462b and 1462c have been visually emphasized.

FIG. 13e depicts a third example of an illustrative image 1300 conveying contents of a receptacle. The processing unit 300 processes the image 1300 to derive information conveying a region of interest, denoted as 1302 in FIG. 13e. FIG. 13f depicts a first enhanced version of the image of FIG. 13e, which is referred to as enhanced image 1304. In this example, the enhanced image 1304 is such that portions of the image which lie outside the region of interest 1302 have been visually de-emphasized. The de-emphasis is illustrated in this case by features appearing in portions of the image that lie outside the region of interest 1302 being presented in dotted lines. FIG. 13g depicts a second enhanced version of the image of FIG. 13e, which is referred to as enhanced image 1306. In this example, the enhanced image 1306 is such that features appearing inside the region of interest 1302 have been visually emphasized. The emphasis is illustrated in this case by features appearing in the region of interest 1302 being enlarged such that features of the enhanced image 1306 located inside the region of interest 1302 appear on a larger scale than features in portions of the enhanced image 1306 located outside the region of interest 1302.

De-Emphasizing Portions of an Image Outside a Region of Interest

With renewed reference to FIG. 3, the processing unit 300 may process the image received at the input 304 to generate an enhanced image wherein portions outside the region of interest, conveyed by information received at the second input 306 from the automated threat detection processing module 106, are visually de-emphasized. Any suitable image manipulation technique for de-emphasizing the visual appearance of portions of the image outside the region of interest may be used by the processing unit 300. Such image manipulation techniques are well known and as such will not be described in detail here.

In one example, the processing unit 300 may process the image received at the input 304 to attenuate portions of the image outside the region of interest. For instance, the processing unit 300 may process the image to reduce contrasts between feature information appearing in portions of the image outside the region of interest and background information appearing in portions of the image outside the region of interest. Alternatively, the processing unit 300 may process the image to remove features from portions of the image outside the region of interest. In yet another alternative, the processing unit 300 may process the image to remove all features appearing in portions of the image outside the region of interest such that only features in the area of interest remain in the enhanced image.

In another example, the processing unit 300 may process the image to overlay or replace portions of the image outside the region of interest with a pre-determined visual pattern. The pre-determined visual pattern may be a suitable textured pattern of may be a uniform pattern. The uniform pattern may be a uniform color or other uniform pattern.

In yet another example, where the image includes color information, the processing unit 300 may process the image to modify color information associated to features of the image appearing outside the region of interest. For instance, portions of the image outside the region of interest may be converted into grayscale or another monochromatic color palette.

In yet another example, the processing unit 300 may process the image to reduce the resolution associated to portions of the image outside the region of interest. This type of image manipulation results in portions of the enhanced image outside the region of interest appearing blurred compared to portions of the image inside the region of interest.

In yet another example, the processing unit 300 may process the image to shrink portions of the image outside the region of interest such that at least some features of the enhanced image located inside the region of interest appear on a larger scale than features in portions of the enhanced image located outside the region of interest.

It will be appreciated that the above-described exemplary techniques for de-emphasizing the visual appearance of portions of the image outside the region of interest may be used individually or in combination with one another. It will also be appreciated that the above-described exemplary techniques for de-emphasizing the visual appearance of portions of the image outside the region of interest are not meant as an exhaustive list of such techniques and that other suitable techniques may be used.

Emphasizing Features Appearing Inside a Region of Interest

The processing unit 300 may process the image received at the input 304 to generate an enhanced image wherein features appearing inside a region of interest, conveyed by information received at the second input 306 from the automated threat detection processing module 106, are visually emphasized. Any suitable image manipulation technique for emphasizing the visual appearance of features of the image inside the region of interest may be used. Such image manipulation techniques are well known and as such will not be described in detail here.

In one example, the processing unit 300 may process the image to increase contrasts between feature information appearing in portions of the image inside the region of interest and background information appearing in portions of the image inside the region of interest. For instance, contour lines defining objects inside the region of interest are made to appear darker and/or thicker compared to contour lines in the background. As one possibility, contrast-stretching tools with settings highlighting the metallic content of portions of the image inside the region of interest may be used to enhance the appearance of such features.

In another example, the processing unit 300 may process the image to overlay portions of the image inside the region of interest with a pre-determined visual pattern. The pre-determined visual pattern may be a suitable textured pattern of may be a uniform pattern. The uniform pattern may be a uniform color or other uniform pattern. For instance, portions of the image inside the region of interest may be highlighted by overlaying the region of interest with a brightly colored pattern. The visual pattern may have transparent properties in that the user can see features of the image in portions of the image inside the region of interest through the visual pattern once the pattern is overlaid on the image.

In yet another example, the processing unit 300 may process the image to modify color information associated to features of the image appearing inside the region of interest. For instance, colors for features of the image appearing inside the region of interest may be made to appear brighter or may be replaced by other more visually contrasting colors. In particular, color associated to metallic objects in an x-ray image may be made to appear more prominently by either replacing it with a different color or changing an intensity of the color. For example, the processing unit 300 may transform features appearing in blue inside the region of interest such that these same features appear in red in the enhanced image.

In yet another example, the processing unit 300 may process the image to enlarge a portion of the image inside the region of interest such that at least some features of the enhanced image located inside the region of interest appear on a larger scale than features in portions of the enhanced image located outside the region of interest. FIG. 13g, which has been previously described, depicts an enhanced image derived from the image depicted in FIG. 13e wherein the region of interest 1302 has been enlarged relative to the portions of the image outside the region of interest 1302. The resulting enhanced image 1306 is such that the features inside the region of interest 1302 appear on a different scale that the features appearing in the portions of the image outside the region of interest 1302.

It will be appreciated that the above-described exemplary techniques for emphasizing the visual appearance of portions of the image inside the region of interest may be used individually or in combination with one another or with other suitable techniques. For example, processing the image may include modifying color information associated to features of the image appearing inside the region of interest and enlarging a portion of the image inside the region of interest. It will also be appreciated that the above-described exemplary techniques for emphasizing portions of the image inside the region of interest are not meant as an exhaustive list of such techniques and that other suitable techniques may be used.

Concurrently De-Emphasizing Portions Outside a Region of Interest and Emphasizing Features Inside the Region of Interest

It will be appreciated that, in some embodiments, the processing unit 300 may concurrently de-emphasize portions of the image outside the region of interest and emphasize features of the image inside the region of interest, using a combination of the above-described exemplary techniques and/or other suitable techniques.

Portions Surrounding a Region of Interest

In some embodiments, the processing unit 300 may process the image received at the input 304 to modify portions of areas surrounding the region of interest to generate the enhanced image. For example, the processing unit 300 may modify portions of areas surrounding the region of interest by applying a blurring function to edges surrounding the region of interest. As one possibility, the edges of the region of interest may be blurred. Advantageously, blurring the edges of the region of interest accentuates the contrast between the region of interest and the portions of the image outside the region of interest.

Multiple Regions of Interest

Although the above-described examples relate to situations where a single region of interest is conveyed by the information received by the display control module 200 from the automated threat detection processing module 106, it will be appreciated that similar processing operations may be performed by the processing unit 300 where the information received from the automated threat detection processing module 106 conveys a plurality of regions of interest of the image of contents of the receptacle 104. More particularly, the processing unit 300 is adapted for receiving at the input 306 information from the automated threat detection processing module 106 that conveys a plurality of regions of interest of the image of contents of the receptacle 104. The processing unit 300 then processes the image received at the input 304 to generate the enhanced image using principles describe above.

Graphical User Interface

The graphical user interface implemented by the display control module 200 allows incremental display on the display unit 202 of information pertaining to the receptacle 104 while it is being screened. More specifically, the display control module 200 causes the display unit 202 to display information incrementally as the display control module 200 receives information from the automated threat detection processing module 106.

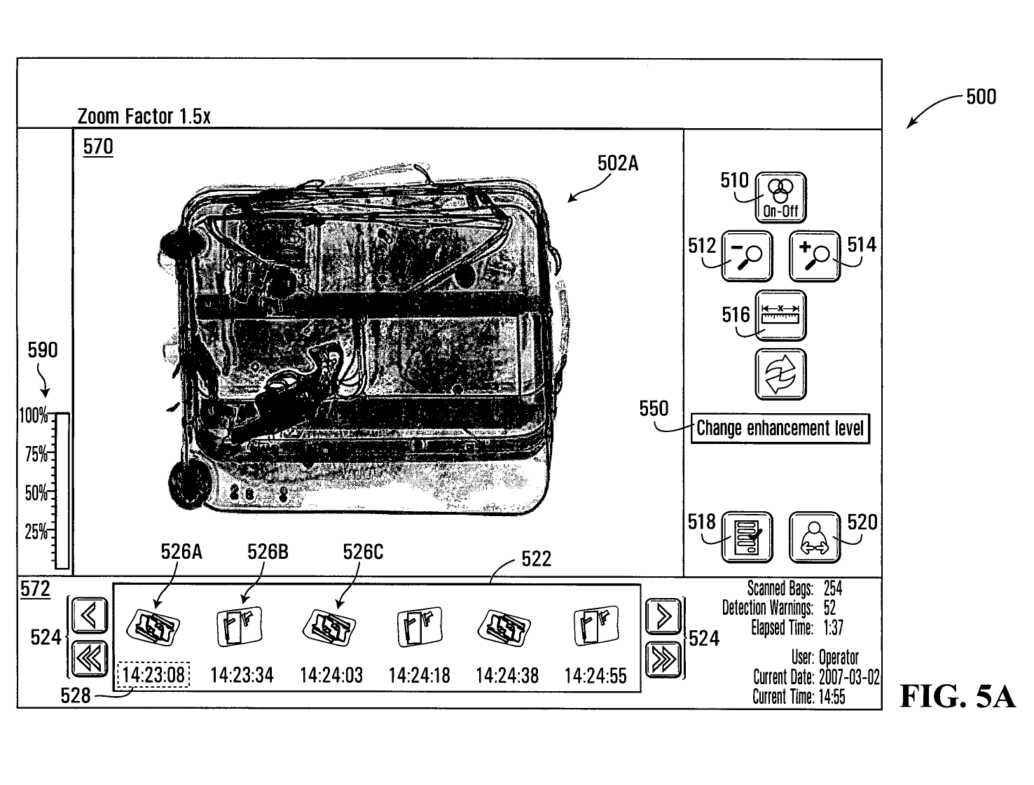

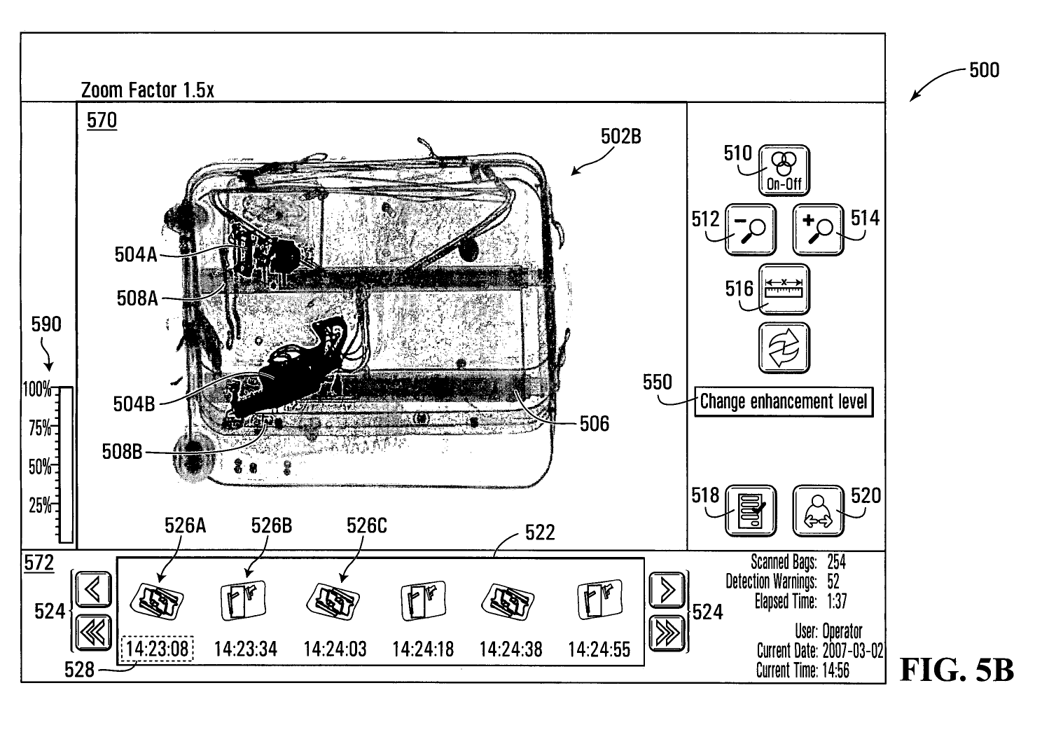

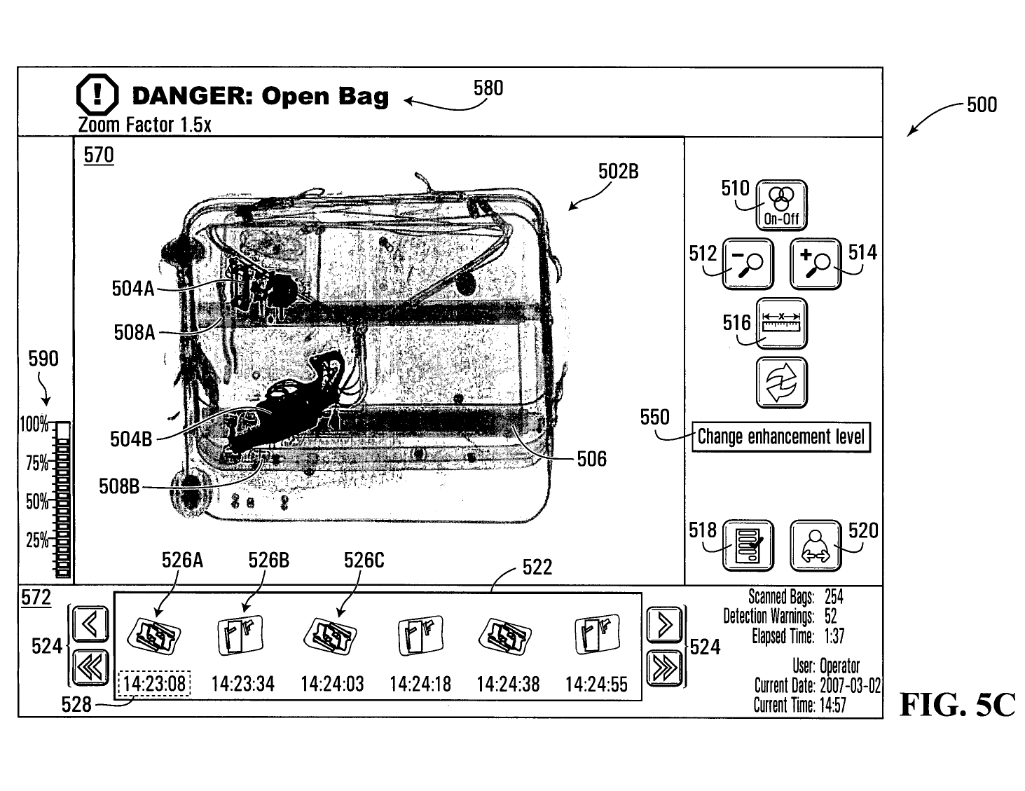

An example of the graphical user interface implemented by the display control module 200 will now be described with reference to FIGS. 5A, 5B and 5C. FIGS. 5A, 5B and 5C illustrate example manifestations of the graphical user interface over time.

More specifically, at time T₀, the data conveying the image of contents of the receptacle 104 derived from the image generation apparatus 102 is received at the input 304 of the display control module 200. At time T₀, the image displayed on the display unit 202 may be an image of a previously screened receptacle or, alternatively, there may no image displayed to the user.

At time T₁ which is later than T₀, an image showing the contents of the receptacle 104 is displayed on the display unit 202. FIG. 5A shows a manifestation of the graphical user interface at time T₀. As depicted, the graphical user interface provides a viewing window 500 including a viewing space 570 for displaying information to the user. The image 502a displayed at time T₁ corresponds to the image derived by the image generation apparatus 102 which was received at the input 304 at time T₀. While the graphical user interface displays the image 502a, the automated threat detection processing module 106 processes the image of the contents of the receptacle 104 derived from the image generation apparatus 102 to identify one or more regions of interest of the image.

At time T₂ which is later than T₁, information conveying the one or more regions of interest of the image is displayed on the display unit 202. FIG. 5B shows a manifestation of the graphical user interface at time T₂. As depicted, the viewing space 570 displays the information conveying the one or more regions of interest of the image in the form of an enhanced image 502b where, in this case, two regions of interest 504a and 504b are displayed to the user in a visually contrasting manner relative to portions of the image 506 which are outside the regions of interest 504a and 504b. In this fashion, the user's attention can be focused on the regions of interest 504a and 504b of the image which are the areas most likely to contain representations of prohibited objects or other threat-posing objects.

In this example, portions of the image outside the regions of interest 504a and 504b have been de-emphasized. Amongst possible other processing operations, portions of the image outside the regions of interest 504a and 504b, generally designated with reference numeral 506, have been attenuated by reducing contrasts between the features and the background. These portions appear paler relative to the regions of interest 504a and 504b. Also, in this example, features depicted in the regions of interest 504a and 504b have been emphasized by using contrast-stretching tools to increase the level of contrast between the features depicted in the regions of interest 504a and 504b and the background. In addition, in this example, the edges 508a and 508b surrounding the regions of interest 504a and 504b have been blurred to accentuate the contrast between the regions of interest 504a and 504b and the portions of the image outside the regions of interest 504a and 504b. The location of the regions of interest 504a and 504b is derived on a basis of the information received at the input 306 from the automated threat detection processing module 106.

While the graphical user interface displays the image 502b, the automated threat detection processing module 106 processes the areas of interest 504A and 504B of the image to derive threat information regarding the receptacle 104.

At time T₃ which is later than T₂, the threat information derived by the automated threat detection processing module 106 is displayed on the display unit 202. FIG. 5C shows a manifestation of the graphical user interface at time T₃. As depicted, in this example, the viewing window 500 displays the threat information in the form of a perceived level of threat associated to the receptacle 104. In this case, the perceived level of threat associated to the receptacle 104 is conveyed through two elements, namely a graphical threat probability scale 590 conveying a likelihood that a threat was positively detected in the receptacle 104 and a message 580 conveying a threat level and/or a handling recommendation.

In one embodiment, a confidence level data element is received at the input 306 of the display control module 200 from the automated threat detection processing module 106. The confidence level conveys a likelihood that a threat was positively detected in the receptacle 104. In the example depicted in FIG. 5C, the graphical threat probability scale 590 conveys a confidence level (or likelihood) that a threat was positively detected in the receptacle 104 and includes various graduated levels of threats. Also, in this example, the message 580 is conditioned on a basis of the confidence level received from the automated threat detection processing module 106 and on a basis of a threshold sensitivity/confidence level. As will be described below, the threshold sensitivity/confidence level may be a parameter configurable by the user or may be a predetermined value. In one example, if the confidence level exceeds the threshold sensitivity/confidence level, a warning message such as “DANGER: OPEN BAG” or “SEARCH REQUIRED” may be displayed. If the confidence level is below the threshold sensitivity/confidence level, either no message may be displayed or an alternative message such as “NO THREAT DETECTED—SEARCH AT YOUR DISCRETION” may be displayed. Optionally, the perceived level of threat conveyed to the user may be conditioned on a basis of external factors such as a national emergency status for example. For instance, the national emergency status may either lower or raise the threshold sensitivity/confidence level such that a warning message of the type “DANGER: OPEN BAG” or “SEARCH REQUIRED” may be displayed at a different confidence level depending on the national emergency status.

While the above-described example illustrates one possible form of threat information regarding the receptacle 104 that may be displayed, it will be appreciated that other forms of threat information may be displayed to the user by the viewing window 500 in other embodiments.

As shown in FIGS. 5A to 5C, the graphical user interface may also provide a set of controls 510, 512, 514, 516, 550 and 518 for allowing the user to provide commands for modifying features of the graphical user interface to change the appearance of the enhanced image 502b displayed in the viewing window 500.

In one embodiment, the controls 510, 512, 514, 516, 550 and 518 allow the user to change the appearance of the enhanced image 502b displayed in the viewing space 570 by using an input device in communication with the display control module 200 through the user input 308. In this example, the controls 510, 512, 514, 516, 550, and 518 are in the form of graphical buttons that can be selectively actuated by the user. In other implementations, controls may be provided as physical buttons (or keys) on a keyboard or other input device that can be selectively actuated by the user. In such implementations, the physical buttons (or keys) are in communication with the display control module 200 through the user input 308. It will be recognized that other suitable forms of controls may also be used in other embodiments.

It will be apparent that certain controls in the set of controls 510 512 514 516 550 518 may be omitted from certain implementations and that additional controls may be included in alternative implementations of user interfaces without detracting from the spirit of the invention.

In this embodiment, functionality is provided to the user for allowing him/her to select for display in the viewing space 570 the “original” image 502a (shown in FIG. 5A) or the enhanced image 502b (shown in FIGS. 5B and 5C). For example, such functionality may be enabled by displaying a control on the graphical user interface allowing the user to effect the selection. In FIGS. 5A to 5C, this control is implemented as a control button 510 which may be actuated by the user via an input device to toggle between the enhanced image 502b and the original image 502a for display in the viewing space 570. It will be appreciated that other manners for providing such functionality may be used in other examples.

In this embodiment, functionality is also provided to the user for allowing him/her to select a level of enlargement from a set of possible levels of enlargement to be applied to the image in order to derive the enhanced image for display in the viewing space 570. The functionality allows the user to independently control the scale of features appearing in the regions of interest 504a and 504b relative to the scale of features in portions of the image outside the regions of interest 504a and 504b. For example, such functionality may be enabled by displaying a control on the graphical user interface allowing the user to effect the selection of the level of enlargement. In FIGS. 5A to 5C, this control is implemented as control buttons 512 and 514 which may be actuated by the user via an input device. In this case, by actuating the button 514, the enlargement factor (“zoom-in”) to be applied to the regions of interest 504a and 504b by the processing unit 300 is increased, while, by actuating the button 512, the enlargement factor (“zoom-out”) to be applied to the regions of interest 504a and 504b (shown in FIGS. 5B and 5C) is decreased. It will be appreciated that that other types of controls for allowing the user to select a level of enlargement from a set of levels of enlargement may be used.

The set of possible levels of enlargement includes at least two levels of enlargement. In one example, one of the levels of enlargement is a “NIL” level wherein features of the portion of the enhanced image inside the region of interest appear on the same scale as features in portions of the enhanced image outside the region of interest. In other examples, the set of possible levels of enlargement includes two or more distinct levels of enlargement other that the “NIL” level. The enhanced image is such that portions inside the regions of interest are enlarged at least in part based on the selected level of enlargement. It will be appreciated that although the above refers to a level of “enlargement” to be applied to the regions of interest 504a and 504b, a corresponding level of “shrinkage” may instead be applied to portions of the image outside the regions of interest 504a and 504b so that in the resulting enhanced image features in the regions of interest appear on a larger scale than portions of the image outside the region of interest.

In some embodiments, functionality may also be provided to the user for allowing him/her to select a zoom level to be applied to derive the enhanced image 502b for display in the viewing space 570. This zoom level functionality differs from the level of enlargement functionality described above, which was enabled by the buttons 512 and 514, in that the zoom level functionality affects the entire image with a selected zoom level. In other words, modifying the zoom level does not affect the relative scale between the regions of interest and portions of the image outside the regions of interest. For example, such functionality may be enabled by displaying a control on the graphical user interface allowing the user to effect the selection of the zoom level.

Functionality may also be provided to the user for allowing him/her to select a level of enhancement from a set of possible levels of enhancement. The functionality allows the user to independently control the type of enhancement to be applied to the original image 502a (shown in FIG. 5a) to generate the enhanced image 502b (shown in FIGS. Fb and 5c) for display in the viewing space 570. The set of possible levels of enhancement includes at least two levels of enhancement. In one example, one of the levels of enhancement is a “NIL” level wherein the regions of interest are not emphasized and the portions of the images outside the regions of interest are not de-emphasized. In other examples, the set of possible levels of enlargement includes two or more distinct levels of enhancement other than the “NIL” level. In one case, each level of enhancement in the set of levels of enhancement is adapted for causing an enhanced image to be derived wherein:
portions inside the regions of interest are visually emphasized at least in part based on the selected level of enhancement; or
portions outside the regions of interest are visually de-emphasized at least in part based on the selected level of enhancement; or
portions inside the regions of interest are visually emphasized and portions outside the regions of interest are visually de-emphasized at least in part based on the selected level of enhancement.

For example, the different levels of enhancement may cause the processing unit 300 to apply different types of image processing functions or different degrees of image processing such as to modify the appearance of the enhanced image 502b displayed in the viewing space 570. This allows the user to adapt the appearance of the enhanced image 502b based on user preferences or in order to view an image in a different manner to facilitate visual identification of a threat. In one embodiment, the above-described functionality may be enabled by providing a control on the graphical user interface allowing the user to effect selection of the level of enhancement. In FIGS. 5A to 5C, this control is implemented as a control button 550, which may be actuated by the user via a user input device. In this example, by actuating the button 550, the type of enhancement to be applied by the processing unit 300 is modified based on a set of predetermined levels of enhancement. In other examples, a control in the form of a drop-down menu providing a set of possible levels of enhancement may be provided. The user is able to select a level of enhancement from the set of levels of enhancement to modify the type of enhancement to be applied by the processing unit 300 to generate the enhanced image. It will be appreciated that other type of controls for allowing the user to select a level of enhancement from a set of levels of enhancement may be implemented in other embodiments.

Functionality may also be provided to the user for allowing him/her to independently control the amount of enhancement to be applied to the one or more regions of interest of the image and the amount of enhancement to be applied to portions of the image outside of the one or more regions of interest. This functionality may be enabled by providing on the graphical user interface a first control for enabling the user to select a first level of enhancement, and a second for allowing the user to select a second level of enhancement. In this case, the processing unit 300 generates the enhanced image such that:
portions inside the one or more regions of interest are visually emphasized at least in part based on the selected second level of enhancement; and
portions outside the one or more regions of interest are visually de-emphasized at least in part based on the selected first level of enhancement.

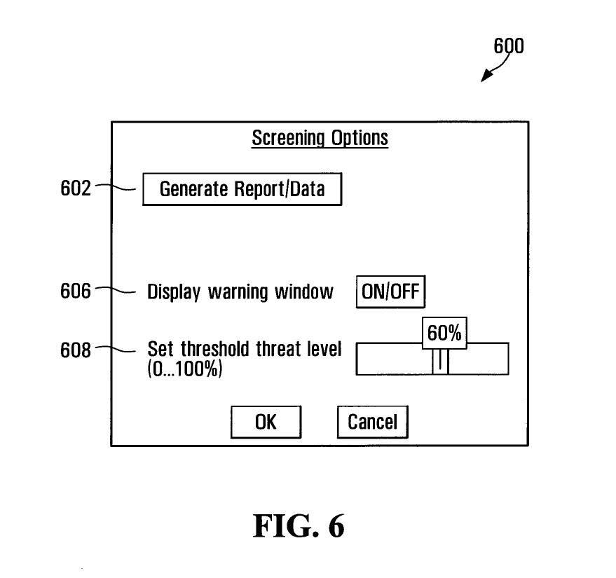

In this embodiment, the graphical user interface provides a control 518 for allowing the user to modify other configuration elements of the graphical user interface. In this case, as shown in FIG. 6, actuating the control 518 causes the graphical user interface to displays a control window 600 allowing the user to select screening options. In this example, the user is enabled to select between the following screening options:
Generate report data 602: this option allows a report to be generated detailing information associated to the screening of the receptacle 104. In this example, this is done by providing a control in the form of a button that can be toggled between an “ON” state and an “OFF” state. It will be appreciated that other suitable forms of controls may be used. The information generated in the report may include, without being limited to, time of the screening, identification of the security personnel operating the screening system, identification of the receptacle and/or receptacle owner (e.g., passport number in the case of a customs screening), location information, region of interest information, confidence level information, identification of a prohibited object detected and description of the handling that took place and the results of the handling, amongst others. Advantageously, this report allows tracking of the screening operation and provides a basis for generating performance metrics of the system 100.
Display warning window 606: this option allows the user to cause a visual indicator in the form of a warning window to be removed from or displayed on the graphical user interface when a threat is detected in a receptacle.
Set threshold sensitivity/confidence level 608: this option allows the user to modify the detection sensitivity level of the screening system. In example implementations, this may be done by providing a control in the form of a text box, sliding ruler (as shown in FIG. 6), selection menu or other suitable type of control allowing the user to select between a range of detection sensitivity levels. It will be appreciated that other suitable forms of controls may be used.

It will be appreciated that other options may be provided to the user and that certain options described above may be omitted from certain implementations. Also, in some cases, certain options may be selectively provided to certain users or, alternatively, may require a password to be modified. For example, the setting threshold sensitivity/confidence level 608 may only be made available to users having certain privileges (e.g., screening supervisors or security directors). As such, the graphical user interface module may implement user identification functionality, such as a login process, to identify the user of the system 100. Alternatively, the graphical user interface, upon selection by the user of the setting threshold sensitivity/confidence level 608 option, may prompt the user to enter a password for allowing the user to modify the detection sensitivity level of the system 100.

In this embodiment, the graphical user interface provides a control 520 for allowing the user to login/logout of the system 100 using user identification functionality. Such user identification functionality is well known and as such will not be described here.

In some embodiments, the graphical user interface may provide functionality to allow the user to add complementary information to the information being displayed on the graphical user interface. For example, the user may be enabled to insert markings in the form of text and/or visual indicators in the image displayed in viewing space 570. The marked-up image may then be transmitted to a third-party location, such as a checking station, so that the checking station is alerted to verify the marked portion of the image to locate a prohibited or other threat-posing object. In such an implementation, the user input 308 receives signals from a user input device, the signals conveying commands for marking the image displayed in the graphical user interface.

Previously Screened Receptacles

With reference to FIG. 3, in this embodiment, the display control module 200 is adapted for storing information associated with receptacles being screened so that this information may be accessed at a later time. More specifically, for a given receptacle, the display control module 200 is adapted for receiving at the first input 304 data conveying an image of contents of the receptacle. The display control module 200 is also adapted for receiving at the second input 306 information from the automated threat detection processing module 106. The processing unit 300 of display control module 200 is adapted for generating a record associated to the screened receptacle. The record includes the image of the contents of the receptacle received at the first input 304 and optionally the information received at the second input 306. In some examples of implementation, the record for a given screened receptacle may include additional information such as for example an identification of the area(s) of interest in the image, a time stamp, identification data conveying the type of prohibited or other threat-posing object potentially detected, the level of confidence of the detection of a threat, a level of risk data element, an identification of the screener, the location of the screening station, identification information associated to the owner of the receptacle and/or any other suitable type of information that may be of interest to a user of the system for later retrieval. The record is then stored in a memory 350.

Generation of a record may be effected for all receptacles being screened or for selected receptacles only. In practical implementations, in particular in cases where the system 100 is used to screen a large number of receptacles, it may be preferred to selectively store the images of certain receptacles rather than storing images for all the receptacles. The selection of which images to store may be effected by the user of the graphical user interface by providing a suitable control on the graphical user interface for receiving user commands to that effect. Alternatively, the selection of which images to store may be effected on a basis of information received from the automated threat detection processing module 106. For example, a record may be generated for a given receptacle when a threat was potentially detected in the receptacle as could be conveyed by data received from the automated threat detection processing module 106.

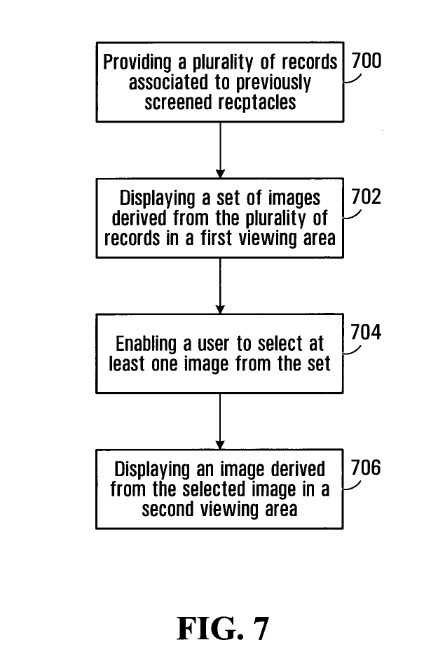

An example process for facilitating visual identification of threats in images associated with previously screened receptacles is depicted in FIG. 7.

In this example, at step 700, a plurality of records associated to previously screened receptacles are provided. For instance, the display control module 200 may enable step 700 by providing the memory 350 for storing a plurality of records associated to previously screened receptacles. As described above, each record includes an image of contents of a receptacle derived from the image generation apparatus 102 and information derived by the automated threat detection processing module 106.

At step 702, a set of thumbnail images derived from the plurality of records is displayed. As shown in FIGS. 5A to 5B, a set of thumbnail images 522 is displayed in a viewing space 572, each thumbnail image 526a, 526b and 526c in the set of thumbnail images 522 being derived from a record in the plurality of records stored in memory unit 350.

At step 704, the user is enabled to select at least one thumbnail image from the set of thumbnail images. The selection may be effected on a basis of the images themselves or by allowing the user to specify either a time or time period associated to the records. In FIGS. 5A to C, the user can select a thumbnail image from the set of thumbnail images 522 using a user input device to actuate the desired thumbnail image.

At step 706, an enhanced image derived from a record corresponding to the selected thumbnail image is displayed in a viewing space on the graphical user interface. In FIGS. 5A to 5C, in response to a selection of a thumbnail image from the set of thumbnail images 522, an enhanced image derived from the certain record corresponding to the selected thumbnail image is displayed in the viewing space 570. When multiple thumbnail images are selected, the corresponding enhanced images may be displayed concurrently with another or may be displayed separately in the viewing space 570.

The enhanced imaged derived from the certain record corresponding to the selected thumbnail image may be derived in a manner similar to that described previously. For example, a given record in the memory 350 includes a certain image of contents of a receptacle and information conveying one or more regions of interest in the certain image. In one example, portions of the certain image outside the one or more regions of interest may be visually de-emphasized to generate the enhanced image. In another example, features appearing inside the one or more regions of interest may be visually emphasized to generate the enhanced image. In yet another example, the portions of the image outside the one or more regions of interest may be visually de-emphasized and features appearing inside the one or more regions of interest may be visually emphasized to generate the enhanced image. Manners in which the portions of the certain image outside the one or more regions of interest may be visually de-emphasized and features appearing inside the one or more regions of interest may visually emphasized have been previously described.

With reference to FIGS. 5A to 5C, in this embodiment, functionality is also provided to the user for allowing him/her to scroll through a plurality of thumbnail images so that different sets of thumbnail images may be displayed in the viewing space 572. This functionality may be enabled by displaying a control on the graphical user interface allowing the user to scroll through the plurality of thumbnail images. In FIGS. 5A to 5C, this control is implemented as scrolling controls 524 which may be actuated by the user via a suitable user input device.

Each thumbnail image in the set of thumbnail images may convey information derived from an associated time stamp data element. In the example depicted in FIGS. 5A to 5C, this is done by displaying timing information 528. Each thumbnail image in the set of thumbnail images may also convey information derived from a confidence level data element. It will be appreciated that that any suitable additional information may be displayed or conveyed in connection with the thumbnail images.

The graphical user interface implemented by the display control module 200 may also provide functionality for enabling the user to select between an enhanced image associated to a previously screened receptacle (an enhanced previous image) and an enhanced image associated with a currently screened receptacle. More specifically, with reference to FIG. 3, data conveying an image of contents of a currently screened receptacle derived from the image generation apparatus 102 is received at the first input 304 of the display control module 200. In addition, information from the automated threat detection processing module 106 indicating one or more regions of interest in the current image is received at the second input 306 of the display control module 200. The processing unit 300 is adapted for processing the current image to generate information in the form of an enhanced current image. The graphical user interface enables the user to select between an enhanced previous image and the enhanced current image by providing a user operable control (not shown) to effect the selection.

Reference Database 110

With reference to FIG. 2, it is recalled that the processing unit 250 of the processing system 120 has access to the reference database 110. The reference database 110 includes a plurality of records associated with respective threat-posing objects that the processing system 120 is designed to detect.

A record in the reference database 110 that is associated with a particular threat-posing object includes data associated with the particular threat-posing object.

The data associated with the particular threat-posing object may comprise one or more representations (e.g., images) of the particular threat-posing object. Where plural representations of the particular target object are provided, they may represent the particular target object in various orientations. The format of the one or more representations of the particular target object will depend upon one or more image processing algorithms implemented by the automated threat detection processing module 106, which is described later. More specifically, the format of the representations is such that a comparison operation can be performed by the automated threat detection processing module 106 between a representation of a threat-posing object and the image data conveying the image of contents of the receptacle 104 generated by the image generation apparatus 102. For example, in some embodiments, the representations in the reference database 110 may be x-ray images of objects or may be contours of objects.

The data associated with the particular threat-posing object may also comprise characteristics of the particular threat-posing object. Such characteristics may include, without being limited to, a name of the particular threat-posing object, the material composition of the particular threat-posing object, a threat level associated with the particular threat-posing object, the recommended handling procedure when the particular threat-posing object is detected, and any other suitable information.

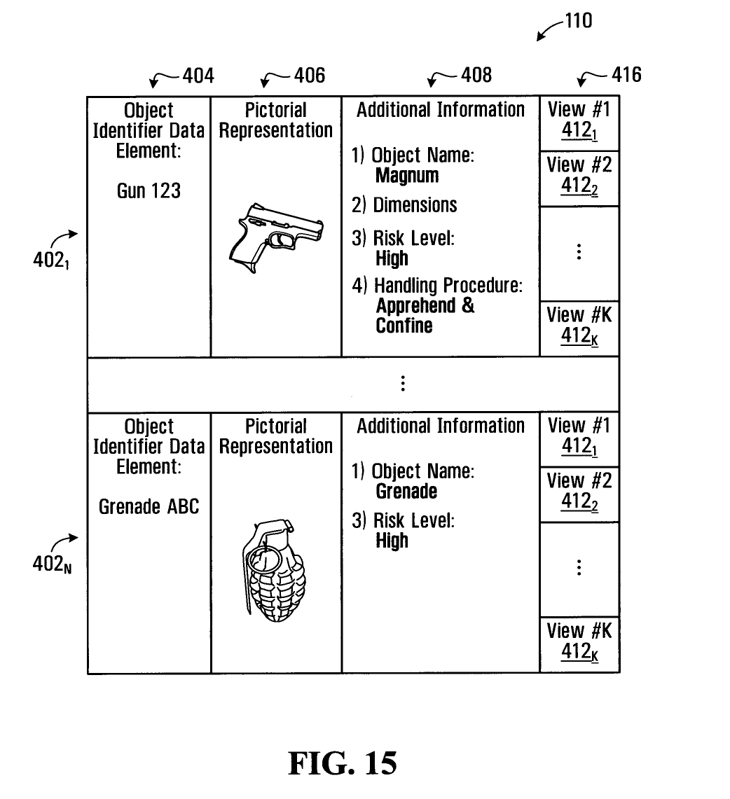

FIG. 15 illustrates an example of data that may be stored in the reference database 110 (e.g., on a computer readable medium).

In this example, the reference database 110 comprises a plurality of records 402₁-402_{N}, each record 402ₙ (1≦n≦N) being associated to a respective threat-posing object whose presence in a receptacle it is desirable to detect.

The types of threat-posing objects having entries in the database 110 will depend upon the application in which the reference database 110 is being used and on the threat-posing objects the system 100 is designed to detect.

For example, in the case of luggage screening (e.g., in an airport facility) the threat-posing objects for which there are entries in the reference database 110 are objects which typically pose potential security threats to passengers (e.g., of an aircraft). In the case of mail parcel screening, the threat-posing objects for which there are entries in the reference database 110 are objects which are typically not permitted to be sent through the mail, such as guns (e.g., in Canada) for example, due to registration requirements/permits and so on. Thus, a threat-posing object for which there is an entry in the reference database 110 may be a prohibited object such as a weapon (e.g., a gun, a knife, an explosive device, etc.). A threat-posing object for which there is an entry in the reference database 110 may not be prohibited but still represent a potential threat. For instance, in the case of luggage screening, a threat-posing object may be a metal plate or a metal canister in an item of luggage that, although not necessarily prohibited in itself, may conceal one or more dangerous objects. As such, it is desirable to be able to detect presence of such threat-posing objects which may not necessarily be prohibited, in order to bring them to the attention of the user of the system 100.

The record 402ₙ associated with a given threat-posing object comprises data associated with the given threat-posing object.

More particularly, in this embodiment, the record 402ₙ associated with the given threat-posing object comprises one or more entries 412₁-412_{K}. In this case, each entry 412ₖ (1≦k≦K) is associated to the given threat-posing object in a respective orientation. For instance, in the example shown in FIG. 15, an entry 412₁ is associated to a first orientation of the given threat-posing object (in this case, a gun identified as “Gun123”); an entry 412₂ is associated to a second orientation of the given threat-posing object; and an entry 418_{K} is associated to a K^{th} orientation of the given threat-posing object. Each orientation of the given threat-posing object can correspond to an image of the given threat-posing object or a contour of the given threat-posing object taken when the given threat-posing object is in a different position.

The number of entries 412₁-412_{K} in a given record 402n may depend on a number of factors such as the type of application in which the reference database 110 is intended to be used, the nature of the given threat-posing object associated to the given record 402n, and the desired speed and accuracy of the overall system 100 in which the reference database 110 is intended to be used. More specifically, certain objects have shapes that, due to their symmetric properties, do not require a large number of orientations in order to be adequately represented. Take for example images of a spherical object which, irrespective of the spherical object's orientation, will look substantially identical to one another and therefore the group of entries 412₁-412_{K} may include a single entry for such an object. However, an object having a more complex shape, such as a gun, would require multiple entries in order to represent the different appearances of the object when in different orientations. The greater the number of entries in the group of entries 412₁-412_{K} for a given threat-posing object, the more precise the attempt to detect a representation of the given threat-posing object in an image of a receptacle can be. This may entail a larger number of entries to be processed which increases the time required to complete the processing. Conversely, the smaller the number of entries in the group of entries 412₁-412_{K} for a given threat-posing object, the faster the speed of the processing can be performed but the less precise the detection of that threat-posing object in an image of a receptacle. As such, the number of entries in a given record 402ₙ is a trade-off between the desired speed and accuracy and may depend on the threat-posing object itself as well.

In accordance with an embodiment of the present invention, and as further described later on, the processing system 120 has parallel processing capability that can be used to efficiently process entries in the reference database 110 such that even with large numbers of entries, processing times remain relatively small for practical implementations of the system 100 where processing speed is an important factor. This is particularly beneficial, for instance, in cases where the system 100 is used for security screening of items of luggage where screening time is a major consideration.

In this example, each entry 412ₖ in the record 402ₙ associated with a given threat-posing object comprises data suitable for being processed by the automated threat detection processing module 106, which implements a comparison operation between that data and the image data conveying the image of contents of the receptacle 104 derived from the image generation apparatus 102 in an attempt to detect a representation of the given threat-posing object in the image of contents of the receptacle 104.

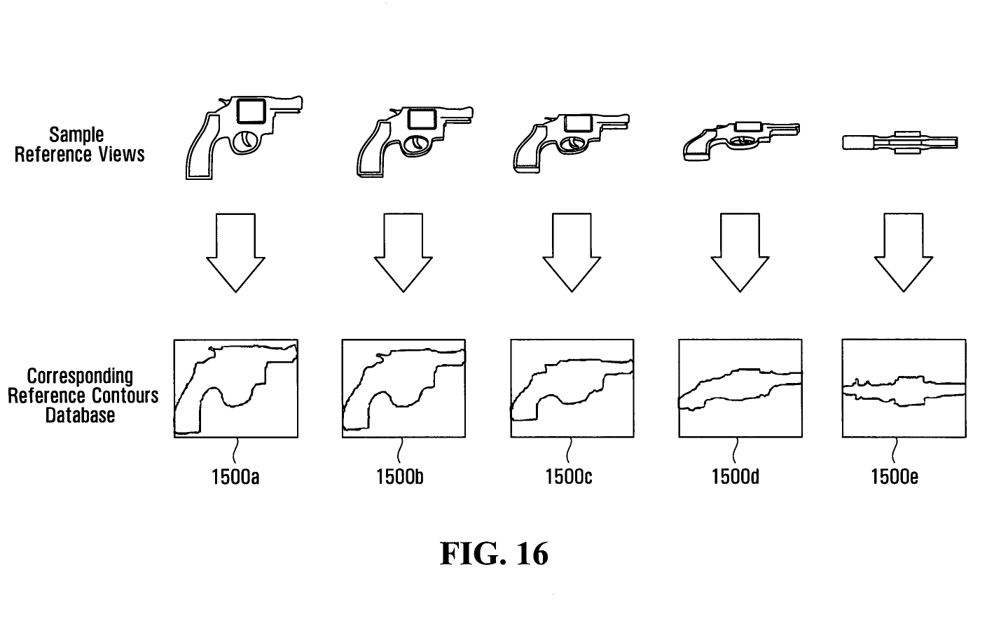

More particularly, in this example, each entry 412ₖ in the record 402ₙ associated with the given threat-posing object comprises a representation of the given threat-posing object (i.e., data pertaining to a representation of the given threat-posing object). For example, the representation of the given threat-posing object may be an image of the given threat-posing object in a certain orientation. As another example, the representation of the given threat-posing object may be an image of a contour of the given threat-posing object when in a certain orientation. FIG. 16 illustrates an example of a set of contour images 1500a to 1500e of a threat-posing object (in this case, a gun) in different orientations. As yet another example, the representation of the given threat-posing object may be a filter derived based on an image of the given threat-posing object in a certain orientation. For instance, the filter may be indicative of a Fourier transform (or Fourier transform complex conjugate) of the image of the given threat-posing object in the certain orientation.

The record 402ₙ associated with a given threat-posing object may also comprise data 406 suitable for being processed by the display control module 200 to derive a pictorial representation of the given threat-posing object for display as part of the graphical user interface. Any suitable format for storing the data 406 may be used. Examples of such formats include, without being limited to, bitmap, JPEG, GIF, or any other suitable format in which a pictorial representation of an object may be stored.

The record 402ₙ associated with a given threat-posing object may also comprise additional information 408 associated with the given threat-posing object. The additional information 408 will depend upon the type of given threat-posing object as well as the specific application in which the reference database 110 is used. Examples of the additional information 408 include, without being limited to:
a risk level associated with the given threat-posing object;
a handling procedure associated with the given threat-posing object;
a dimension associated with the given threat-posing object;
a material composition of the given threat-posing object;
a weight information element associated with the given threat-posing object;
a description of the given threat-posing object;
a monetary value associated with the given threat-posing object or an information element allowing a monetary value associated with the given threat-posing object to be derived; and
any other type of information associated with the given threat-posing object that may be useful in the application in which the reference database 110 is used.

In one example, the risk level associated to the given threat-posing object (first example above) may convey the relative risk level of the given threat-posing object compared to other threat-posing objects in the reference database 110. For example, a gun would be given a relatively high risk level, while a metallic nail file would be given a relatively low risk level, and a pocket knife would be given a risk level between that of the nail file and the gun.

The record 402ₙ associated with a given threat-posing object may also comprise an identifier 404. The identifier 404 allows each record 402ₙ in the reference database 110 to be uniquely identified and accessed for processing.

Although the reference database 110 has been described with reference to FIG. 15 as including certain types of information, it will be appreciated that the specific design and content of the reference database 110 may vary from one embodiment to another, and may depend upon the application in which the reference database 110 is used.

Also, although the reference database 110 is shown in FIG. 2 as being a component separate from the automated threat detection processing module 106, it will be appreciated that, in some embodiments, the reference database 110 may be part of the processor 106. It will also be appreciated that, in certain embodiments, the reference database 110 may be shared between multiple automated threat detection processing modules such as the automated threat detection processing module 106.

Automated Threat Detection Processing Module 106

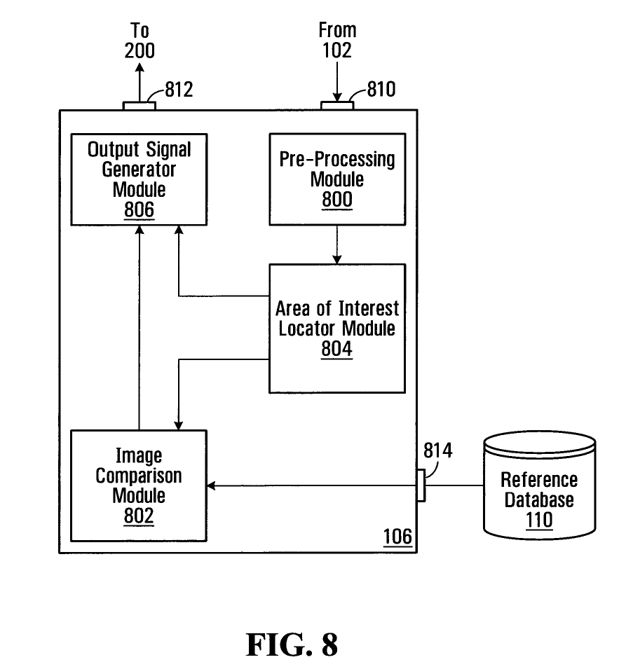

FIG. 8 shows an embodiment of the automated threat detection processing module 106. In this embodiment, the automated threat detection processing module 106 comprises a first input 810, a second input 814, an output 812, and a processing unit, which comprises a pre-processing module 800, an region of interest locator module 804, an image comparison module 802, and an output signal generator module 806.

The processing unit of the automated threat detection processing module 106 receives at the first input 810 the image data conveying the image of contents of the receptacle 104 derived from the image generation apparatus 102. The processing unit of the automated threat detection processing module 106 processes the received image data to identify one or more regions of interest of the image and threat information regarding the receptacle 104. As part of its processing operations, the processing unit of the automated threat detection processing module 106 obtains via the second input 814 data included in the reference database 110. The processing unit of the automated threat detection processing module 106 also generates and releases to the display control module 200 via the output 812 information conveying the one or more regions of interest of the image and the threat information for display on the display unit 200.

More particularly, in this embodiment, the pre-processing module 800 receives the image data conveying the image of contents of the receptacle 104 via the first input 810. The pre-processing module 800 processes the received image data in order to remove extraneous information from the image and remove noise artifacts in order to obtain more accurate comparison results later on.

The region of interest locator module 804 is adapted for generating data conveying one or more regions of interest of the image of contents of the receptacle 104 based on characteristics intrinsic to that image. For example, where the image is an x-ray image, the characteristics intrinsic to the image may include, without being limited to, density information and material class information conveyed by an x-ray-type image.

The image comparison module 802 receives the data conveying the one or more regions of interest of the image from the region of interest locator module 804. The image comparison module 802 is adapted for effecting a comparison operation between, on the one hand, the received data conveying the one or more regions of interest of the image and, on the other hand, data included in entries of the reference database 110 that are associated with threat-posing objects, in an attempt to detect a representation of one or more of these threat-posing object in the image of contents of the receptacle 104. Based on results of this comparison operation, the image comparison module 802 is adapted to derive threat information regarding the receptacle 104. As mentioned above, the threat information regarding the receptacle 104 can be any information regarding a threat potentially represented by one or more objects contained in the receptacle 104. For example, the threat information may indicate that one or more threat-posing objects are deemed to be present in the receptacle 104. In some cases, the threat information may identify each of the one or more threat-posing objects. As another example, the threat information may indicate a level of confidence that the receptacle 104 contains one or more objects that represent a threat. As yet another example, the threat information may indicate a level of threat (e.g., low, medium or high; or a percentage) represented by the receptacle 104. In other examples, the threat information may include various other information elements.

The output signal generator module 806 receives information conveying the one or more regions of interest of the image from the region of interest locator module 804 and the threat information regarding the receptacle 104 from the image comparison module 802. The output signal generator module 806 processes this information to generate signals released via the output 312 to the display control module 200, which uses these signals to cause the display unit 200 to display information indicating the one or more regions of interest of the image and the threat information regarding the receptacle 104.

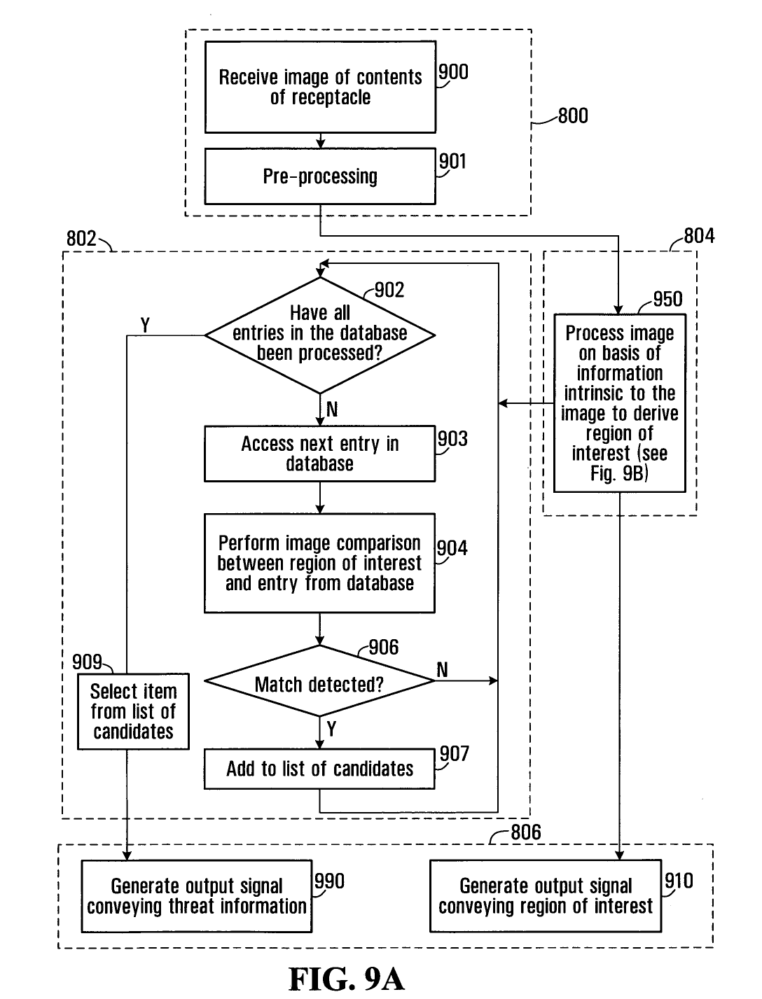

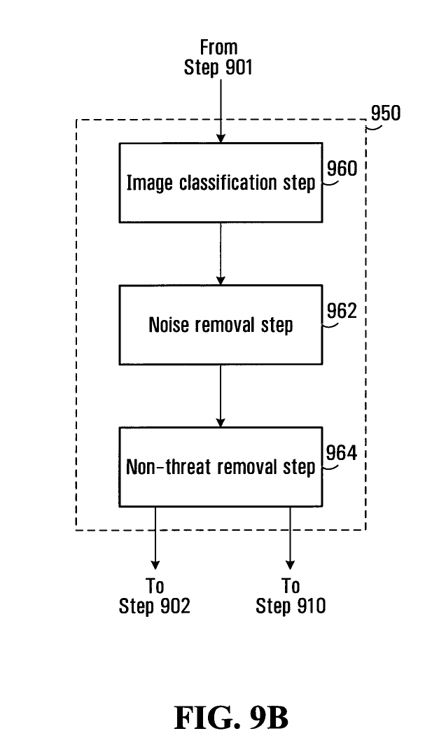

An example of a process implemented by the various functional elements of the processing unit of the automated threat detection processing module 106 will now be described with reference to FIGS. 9A and 9B.

As shown in FIG. 9A, in this example, at step 900, the pre-processing module 800 receives the image data conveying the image of contents of the receptacle 104 via the first input 810. At step 901, the pre-processing module 800 processes the data in order to improve the image, remove extraneous information therefrom and remove noise artifacts in order to obtain more accurate comparison results. The complexity of the requisite level of pre-processing and the related trade-offs between speed and accuracy depend on the application. Examples of pre-processing may include, without being limited to, brightness and contrast manipulation, histogram modification, noise removal and filtering, amongst others. It will be appreciated that all or part of the functionality of the pre-processing module 800 may actually be external to the automated threat detection processing module 106. For instance, it may be integrated as part of the image generation apparatus 102 or as an external component. It will also be appreciated that the pre-processing module 800 (and hence step 901) may be omitted in certain embodiments of the present invention. As part of step 901, the pre-processing module 800 releases data conveying a modified image of contents of the receptacle 104 for processing by the region of interest locator module 804.

At step 950, the region of interest locator module 804 processes the image data conveying the modified image received from the pre-processing module 800 (or the image data conveying the image of contents of the receptacle received via the first input 810, if step 901 is omitted) to generate information identifying one or more regions of interest in the image. Any suitable method to identify a region of interest of the image (or modified image) of contents of the receptacle 104 may be used. In one example, the region of interest locator module 804 is adapted for generating information identifying one or more regions of interest of the image based on characteristics intrinsic to the image. For instance, where the image is an x-ray image, the characteristics intrinsic to the image may include, without being limited to, density information and material class information conveyed by the image. The region of interest locator module 804 is adapted to process the image and identify regions including a certain concentration of elements characterized by a certain material density, say for example metallic-type elements, and label these areas as regions of interest. Characteristics such as the size of the area exhibiting the certain density may also be taken into account to identify an region of interest.

FIG. 9B depicts an example of implementation of step 950. In this example, at step 960, an image classification step is performed whereby each pixel of the image received from the pre-processing module 800 is assigned to a respective class from a group of classes. The classification of each pixel is based upon information in the image received via the first input 810 such as, for example, information related to material density. Any suitable method may be used to establish the specific classes and the manner in which a pixel is assigned to a given class. Pixels assigned to classes corresponding to certain material densities, such as for example densities corresponding to metallic-type elements, are then provisionally labeled as candidate regions of interest. At step 962, the pixels provisionally labeled as candidate regions of interest are processed to remove noise artifacts. More specifically, the purpose of step 962 is to reduce the number of candidate regions of interest by eliminating from consideration areas that are too small to constitute a significant threat. For instance, isolated pixels provisionally classified as candidate regions of interest or groupings of pixels provisionally classified as candidate regions of interest which have an area smaller than a certain threshold area may be discarded by step 962. The result of step 962 is a reduced number of candidate regions of interest. The candidate regions of interests remaining after step 962 are processed at step 964.

At step 964, the candidate regions of interest of the image remaining after step 952 are processed to remove regions corresponding to identifiable non-threat-posing objects. The purpose of step 964 is to further reduce the candidate number of regions of interest by eliminating from consideration areas corresponding to non-threat-posing objects frequently encountered during security screening operations (e.g., luggage screening operations) for which the system 100 is used. For instance, examples of identifiable non-threat-posing objects that correspond to non-threat-posing objects frequently encountered during luggage security screening include, without being limited to:
coins
belt buckles
keys
uniform rectangular regions corresponding to the handle bars of luggage
binders
others. . . .

The identification of such non-threat-posing objects in an image may be based on any suitable technique. For example, the identification of such non-threat-posing objects may be performed using any suitable statistical tools. In one case, non-threat removal is based on shape analysis techniques such as, for example, spatial frequency estimation, Hough transform, variant spatial moments, surface and perimeter properties, or any suitable statistical classification techniques tuned to minimize the probability of removing a real threat.

It will be appreciated that step 964 is an optional step and that other embodiments may make use of different criteria to discard a candidate region of interest. In yet other embodiments, step 964 may be omitted altogether.

Thus, the result of step 964 is a reduced number of candidate regions of interest, which are deemed to be (actual) regions of interest that will be processed according to steps 902 and 910 described below with reference to FIG. 9A.

It will be appreciated that other suitable techniques other that the one described above in connection with FIG. 9B for identifying regions of interest may be used in other embodiments.

Returning to FIG. 9A, at step 910, the output signal generator module 806 receives from the region of interest locator module 804 information conveying the one or more regions of interest that were identified at step 950. The output signal generator module 806 then causes this information to be released at the output 812 of the automated threat detection processing module 106. The information conveying the one or more regions of interest includes position information associated to a potential threat within the image of contents of the receptacle 104 received at the input 810. The position information may be in any suitable format. For example, the position information may include a plurality of (X,Y) pixel locations defining an area in the image of contents of the receptacle 104. In another example, the information may include an (X,Y) pixel location conveying the center of an area in the image. As described previously, this information is used by the display control module 200 to cause the display unit 200 to display information conveying the one or more regions of interest of the image of contents of the receptacle 104.

While the output signal generator module 806 is performing step 910, the image comparison module 802 initiates step 902. At step 902, the image comparison module 802 verifies whether there remains in the reference database 110 any unprocessed entry 412ⱼ (of the entries in the records 402₁-402_{N}) which includes a representation of a given threat-posing object. In the affirmative, the image comparison module 802 proceeds to step 903 where the next entry 412ⱼ is accessed and then proceeds to step 904. If at step 902 all of the entries in the reference database 110 have been processed, the image comparison module 802 proceeds to step 909, which will be described later below.

At step 904, the image comparison module 802 compares each of the one or more regions of interest identified at step 950 by the region of interest locator module 804 against the entry 412ⱼ (which includes a representation of a given threat-posing object) accessed at step 903 to determine whether a match exists. The comparison performed by the image comparison module will depend upon the type of entries 412 in the reference database 110 and may be effected using any suitable image processing technique. Examples of techniques that can be used to perform image processing and comparison include, without being limited to:

A—Image Enhancement
Brightness and contrast manipulation
Histogram modification
Noise removal
Filtering

B—Image Segmentation
Thresholding
   Binary or multilevel
   Hysteresis based
   Statistics/histogram analysis
Clustering
Region growing
Splitting and merging
Texture analysis
Blob labeling

C—General Detection
Template matching
Matched filtering
Image registration
Image correlation
Hough transform

D—Edge Detection
Gradient
Laplacian

E—Morphological Image Processing
Binary
   Grayscale
   Blob analysis

F—Frequency Analysis
Fourier Transform

G—Shape Analysis, Form Fitting and Representations
Geometric attributes (e.g. perimeter, area, euler number, compactness)
Spatial moments (invariance)
Fourier descriptors
B-splines
Polygons
   Least Squares Fitting

H—Feature Representation and Classification
Bayesian classifier
Principal component analysis
Binary tree
Graphs
Neural networks
Genetic algorithms

These example techniques are well known in the field of image processing and as such will not be described further here. It will be appreciated that these examples are presented for illustrative purposes only and that other techniques may be used.

In one embodiment, the image comparison module 802 may implement an edge detector to perform part of the comparison at step 904. In another embodiment, the comparison performed at step 904 may include applying a form fitting processing between each region of interest identified by the region of interest locator module 804 and the representation of the given threat-posing object included in the entry 412ⱼ accessed at step 903. In such an embodiment, the representation of the given threat-posing object included in the entry 412ⱼ may be an image of a contour of the given threat-posing object. In yet another embodiment, the comparison performed at step 904 may include effecting a correlation operation between each region of interest identified by the region of interest locator module 804 and the representation of the given threat-posing object included in the entry 412ⱼ accessed at step 903. For example, the correlation operation may be performed by a digital correlator. Alternatively, the correlation operation may be performed by an optical correlator. In yet another embodiment, a combination of methods is used to effect the comparison of step 904 and results of these comparison methods are then combined to obtain a joint comparison result.

In one example of implementation, the entries 412 in the reference database 110 may comprise representations of contours of threat-posing objects that the automated threat detection processing module 106 is designed to detect. The comparison performed by the image comparison module 802 at step 904 processes a region of interest identified at step 950 based on a representation of a contour included in the entry 412ⱼ in the reference database 110 using a least-squares fit process. As part of the least-squares fit process, a score providing an indication as to how well the contour in question fits the shape of the region of interest is generated. Optionally, as part of the least-squares fit process, a scale factor (S) providing an indication as to the change in size between the contour in question and the region of interest may also be generated. The least-squares fit process as well as the determination of the scale factor is well known in the field of image processing and as such will not be described further here.

The result of step 904 is a score associated to entry 412ⱼ accessed at step 903, the score being indicative of a likelihood that the representation of the given threat-posing object included in the entry 412ⱼ is a match to the region of interest under consideration.

The image comparison module 802 then proceeds to step 906 where the result of the comparison effected at step 904 is processed to determine whether a match exists between the region of interest under consideration and the representation of the given threat-posing object included in the entry 412ⱼ accessed at step 903. A likely match is detected if the score obtained by the comparison at step 904 is above a certain threshold score. This score can also be considered as the confidence level associated to detection of a likely match. In the absence of a likely match, the image comparison module 802 returns to step 902. In response to detection of a likely match, the image comparison module 802 proceeds to step 907. At step 907, the entry 412ⱼ of the reference database 110 against which the region of interest was just compared at step 904 is added to a candidate list along with its score. The image comparison module 802 then returns to step 902 to continue processing any unprocessed entries 412 in the reference database 110.

At step 909, which is initiated once all the entries 412 in the database 110 have been processed, the image comparison module 802 processes the candidate list to select therefrom at least one best match. The selection criteria may vary from one implementation to the other but will typically be based upon scores associated to the candidates in the list of candidates. The best candidate is then released to the output signal generator module 806, which proceeds to implement step 990.

It will be appreciated that steps 902, 903, 904, 906, 907 and 909 are performed by the image comparison module 802 for each region of interest identified by the region of interest locator module 804 at step 950. In accordance with an embodiment of the present invention, and as further discussed later on, in cases where the region of interest locator module 804 has identified several regions of interest of the image of contents of the receptacle 104, the image comparison module 802 may process multiple ones of these regions of interest in parallel. To that end, the image comparison module 802 is implemented by suitable hardware and software for enabling such parallel processing of multiple regions of interest. The rational behind processing multiple regions of interests in parallel is that different regions of interest will likely be associated to different potential threats and as such can be processed independently from one another.

At step 990, the output signal generator module 806 generates threat information regarding the receptacle 104 based on information derived by the image comparison module 802 while processing the one or more regions of interest of the image of contents of the receptacle 104. As mentioned above, the threat information regarding the receptacle 104 can be any information regarding a threat potentially represented by one or more objects contained in the receptacle 104. For example, the threat information may indicate that one or more threat-posing objects are deemed to be present in the receptacle 104. In some cases, the threat information may identify each of the one or more threat-posing objects. The identification of a threat-posing object may be achieved based on the best candidate provided at step 909. As another example, the threat information may indicate a level of confidence that the receptacle 104 contains one or more objects that represent a threat. The level of confidence may be derived based on the score associated to the best candidate provided at step 909. As yet another example, the threat information may indicate a level of threat (e.g., low, medium or high; or a percentage) represented by the receptacle 104. The level of threat may be derived on a basis of threat level information included in the reference database 110 in respect of one or more threat-posing objects deemed to be detected. As yet another example, the threat information may indicate a recommended handling procedure for the receptacle 104. The recommended handling procedure may be derived based on the level of confidence (or score) and a pre-determined set of rules guiding establishment of a recommended handling procedure. In other examples, the threat information may include additional information associated to the best candidate provided at step 909. Such additional information may be derived from the reference database 110 and may include information conveying characteristics of the best candidate identified. Such characteristics may include, for instance, the name of the threat (e.g. “gun”), its associated threat level, the recommended handling procedure when such a threat is detected and any other suitable information.

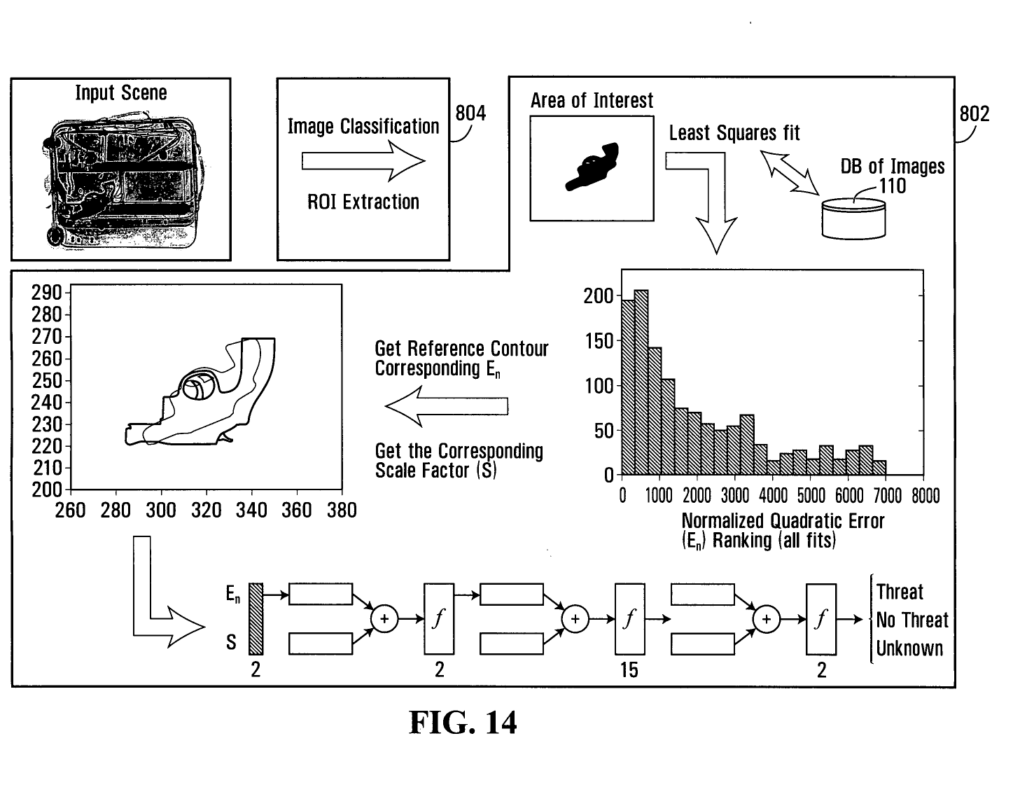

FIG. 14 summarizes graphically steps performed by the region of interest locator module 804 and the image comparison module 802 in an alternative embodiment. In this embodiment, the region of interest locator module 804 processes an input scene image to identify therein one or more regions of interest. Subsequently, for each given region of interest, the image comparison module 802 applies a least-squares fit process for each contour in the reference database 110 and derives an associated quadratic error data element and a scale factor data element for each contour. The image comparison module 802 then makes use of a neural network to determine the likelihood (of confidence level) that the given region of interest contains a representation of a threat. In this case, the neural network makes use of the quadratic error as well as the scale factor generated as part of the least-squares fit process for each contour in the reference database 110 to derive a level of confidence that the region of interest contains a representation of a threat. More specifically, the neural network, which was previously trained using a plurality of images and contours, is operative for classifying the given region of interest identified by the region of interest locator module 804 as either containing a representation of a threat, as containing no representation of a threat or as unknown. In other words, for each class in the following set of classes {threat, no threat, unknown}, a likelihood value conveying the likelihood that the given region of interest belongs to the class is derived by the neural network. The resulting likelihood values are then provided to the output signal generator module 806. The likelihood that the given region of interest belongs to the “threat” class may be used, for example, to derive the information displayed by the threat probability scale 590 (shown in FIG. 5c).

In cases where multiple regions of interests have been identified, the image comparison module 802 processes each region of interest independently in the manner described above to derive a respective level of confidence that the region of interest contains a representation of a threat. The levels of confidence for the multiple regions of interest are then combined to derive a combined level of confidence conveying a level of confidence that the overall image of contents of the receptacle 104 generated by the image generation apparatus 102 contains a representation of a threat. The manner in which the levels of confidence for the respective regions of interest may be combined to derive the combined level of confidence may vary from one implementation to the other. For example, the combined level of confidence may be the level of confidence corresponding to the confidence level of an region of interest associated to the highest level of confidence. For instance, take an image in which three (3) regions of interests were identified and were these three (3) regions of interest were respectively assigned 50%, 60% and 90% as levels of confidence of containing a representation of a threat. The combined level of confidence assigned to the image of contents of the receptacle 104 would be selected as 90%, which corresponds to the highest level of confidence.

Alternatively, the combined level of confidence may be a weighted sum of the confidence levels associated to the regions of interest. Referring to the above example, with an image in which three (3) regions of interests were identified and where these three (3) regions of interest were respectively assigned 50%, 60% and 90% as levels of confidence of containing a representation of a threat, the combined level of confidence assigned to the image of contents of the receptacle 104 in this case may be expressed as follows:

combined level of confidence=w₁*90%+w₂*60%+w₃*50%

where w₁, w₂ and w₃ are respective weights. In practical implementations, the following may apply:

1≧w₁>w₂>w₃≧0

and

combined level of confidence=lesser of {100%; w₁*90%+w₂*60%+w₃*50%}

It will be appreciated that the above examples have been presented for illustrative purposes only and that other techniques for generating a combined level of confidence for the image of contents of the receptacle 104 may be used in other embodiments.

Parallel Processing Architecture

In accordance with an embodiment of the present invention, the processing system 120 implements a parallel processing architecture that enables parallel processing of data in order to improve efficiency of the system 100. More particularly, in this embodiment, in cases where the processing system 120 processes the image data conveying the image of contents of the receptacle 104 and identifies a plurality of regions of interest of the image, the parallel processing architecture allows the processing system 120 to process in parallel these plural regions of interest of the image. Alternatively or in addition, the parallel processing architecture may allow the processing system 120 to process in parallel a plurality of sets of entries in the reference database 110.

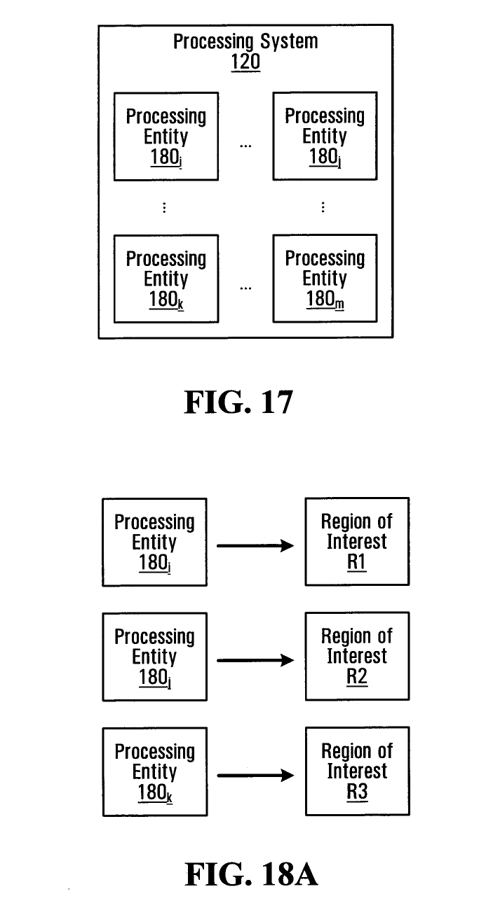

With reference to FIG. 17, there is shown an embodiment of the parallel processing architecture implemented by the processing system 120. In this embodiment, the processing system 120 comprises a plurality of processing entities 180₁-180_{M} that are adapted to perform processing operations in parallel.

Each processing entity 180ₘ (1≦m≦M) comprises at least one processor. In some embodiments, each processor of each processing entity 180ₘ may be a general-purpose processor. In other embodiments, each processor of each processing entity 180ₘ may be an application-specific integrated circuit (ASIC). For example, in one embodiment, each processor of each processing element 180ₘ may be implemented by a field-programmable processor array (FPPA). In yet other embodiments, the processors of certain ones of the processing entities 180₁-180_{M} may be general-purpose processors and the processors of other ones of the processing entities 180₁-180_{M} may be ASICs.

The plurality of processing entities 180₁-180_{M} may comprise any number of processing entities suitable for processing requirements of a screening application in which the processing system 120 is used. In some embodiments, the number of processing entities may be relatively small, while in other embodiments the number of processing entities may be very large in which case the parallel processing architecture can be a massively parallel processing architecture.

Cooperation, coordination and synchronization among the processing entities 180₁-180_{M} may be effected in various ways depending on the nature of the parallel processing architecture implemented by the processing system 120. For example, in various embodiments, the parallel processing architecture may have private memory for each processing entity 180ₘ or memory shared between all or subsets of the processing entities 180₁-180_{M}. Also, the parallel processing architecture may have a shared bus allowing a control entity (e.g., a dedicated processor) to be communicatively coupled to the processing entities 180₁-180_{M} to enable cooperation, coordination and synchronization among the processing entities 180₁-180_{M}. Alternatively, the parallel processing architecture may have an interconnect network linking the processing entities 180₁-180_{M} (e.g., in a topology such as a star, ring, tree, hypercube, fat hypercube, n-dimensional mesh, etc.) and enabling exchange of messages between the processing entities 180₁-180_{M} in order to effect cooperation, coordination and synchronization among the processing entities 180₁-180_{M}. Cooperation, coordination and synchronization considerations in parallel processing architectures are known and as such will not be described in further detail.

The parallel processing architecture implemented by the processing system 120 enables various forms of parallel processing, as will now be discussed.

Parallel Processing of Plural Regions of Interest of the Image of Contents of the Receptacle 102

In this embodiment, in cases where the processing system 120 processes the image data conveying the image of contents of the receptacle 104 and identifies a plurality of regions of interest of the image, the processing system 120 is adapted to process in parallel these plural regions of interest in order to determine if any of these regions of interest depicts a threat-posing object.

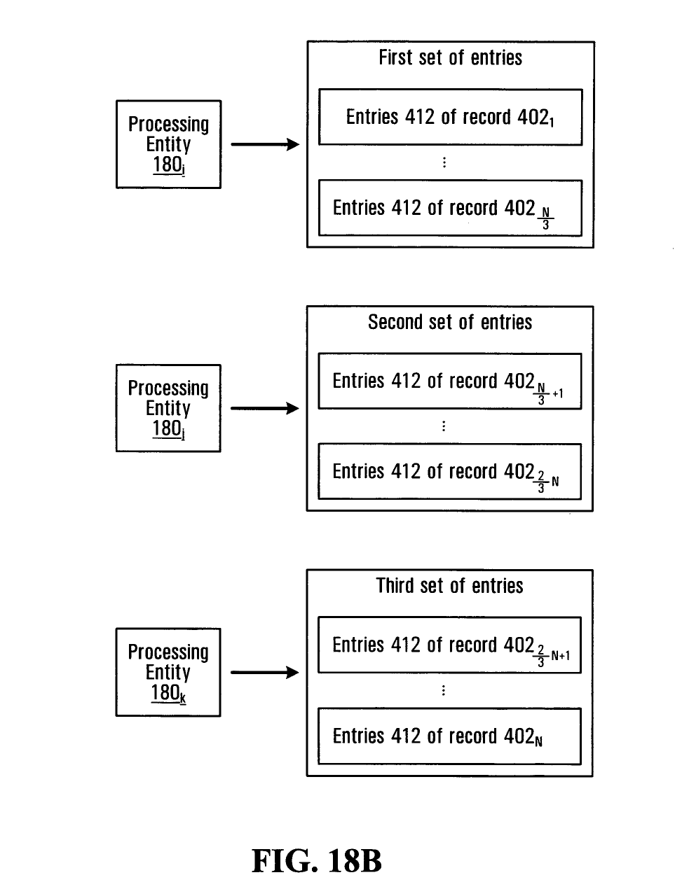

For instance, FIG. 18A illustrates an example where the processing system 120 identifies three (3) regions of interest in the image of contents of the receptacle 104. In this example, different ones of the processing entities 180₁-180_{M} process in parallel these regions of interest in order to determine if any of these regions of interest depicts a threat-posing object. More specifically, in this example: a first processing entity 180ᵢ of the processing entities 180₁-180_{M} processes a first one of the identified regions of interest, denoted R1, to determine if that first region of interest depicts a threat-posing object; a second processing entity 180ⱼ of the processing entities 180₁-180_{M} processes a second one of the identified regions of interest, denoted R2, to determine if that second region of interest depicts a threat-posing object; and a third processing entity 180ₖ of the processing entities 180₁-180_{M} processes a third one of the identified regions of interest, denoted R3, to determine if that third region of interest depicts a threat-posing object. The processing of the three (3) regions of interest R1, R2 and R3 by the processing entities 180ᵢ, 180ⱼ and 180ₖ occurs in parallel. That is, in this example, the processing entities 180ᵢ, 180ⱼ and 180ₖ respectively effect three (3) parallel processing threads, each processing thread processing image data that corresponds to a different one of the regions of interest R1, R2 and R3.

In this embodiment, each processing entity 180ₘ may process a region of interest of the image of contents of the receptacle 104 to determine if that region of interest depicts a threat-posing object, in accordance with steps 902, 903, 904, 906, 907 and 909 described above in connection with FIG. 9A. In other embodiments, other processing may be performed by each processing entity 180ₘ to determine if a region of interest depicts a threat-posing object.

The rational behind processing multiple regions of interest in parallel is that different regions of interest will likely be associated to different potential threats and as such can be processed independently from one another, thereby resulting in processing efficiency for the system 100.

Parallel Processing of Different Sets of Entries in the Reference Database 110

Alternatively or in addition to processing in parallel plural regions of interest of the image of contents of the receptacle 104, the parallel processing architecture may allow the processing system 120 to process in parallel a plurality of sets of entries in the reference database 110 to determine if the image depicts a threat-posing object.

For instance, FIG. 18B illustrates an example where the processing system 120 identifies a region of interest of the image of contents of the receptacle 104. In this example, different ones of the processing entities 180₁-180_{M} process in parallel different sets of entries in the reference database 110 to determine if the region of interest depicts a threat-posing object. More specifically, in this example: a first processing entity 180ᵢ of the processing entities 180₁-180_{M} processes the region of interest in combination with the entries 412₁-412_{K} of each of the records 402₁-402_{N/3} to determine if the region of interest depicts a threat-posing object represented by any of these entries; a second processing entity 180ⱼ of the processing entities 180₁-180_{M} processes the region of interest in combination with the entries 412₁-412_{K} of each of the records 402_{N/3+1}-402_{2N/3} to determine if the region of interest depicts a threat-posing object represented by any of these entries; and a third processing entity 180ₖ of the processing entities 180₁-180_{M} processes the region of interest in combination with the entries 412₁-412_{K} of each of the records 402_{2N/3+1}-402_{N} to determine if the region of interest R depicts a threat-posing object represented by any of these entries. In other words, in this example, each of the processing entities 180ᵢ, 180ⱼ and 180ₖ processes the region of interest in combination with the entries 412₁-412_{K} of one third of the records 402₁-402_{N}. The processing entities 180ᵢ, 180ⱼ and 180ₖ thus process different sets of entries in the reference database 110 in parallel.

In this embodiment, each processing entity 180ₘ may process a region of interest of the image of contents of the receptacle 104 in combination with each entry 412ₖ in the set of entries that it processes to determine if that region of interest depicts a threat-posing object, in accordance with steps 904, 906 and 907 described above in connection with FIG. 9A. In other embodiments, other processing may be performed by each processing entity 180ₘ to determine if a region of interest depicts a threat-posing object.

While in the above-described example different ones of the processing entities 180₁-180_{M} process in parallel different sets of entries in the reference database 110 to determine if a region of interest of the image of contents of the receptacle 104 depicts a threat-posing object, it will be appreciated that, in some embodiments, the processing system 120 may not be designed to identify regions of interest of the image (e.g., the region of interest locator module 804 may be omitted). In such embodiments, different ones of the processing entities 180₁-180_{M} may process in parallel different sets of entries in the reference database 110 in combination with the image data conveying the image of contents of the receptacle 104 to determine if the image depicts a threat-posing object.

The rational behind processing different sets of entries of the reference database 110 in parallel is that each entry 412ₖ in the reference database 110 can be viewed as an independent element and as such can be processed independently from other entries, thereby resulting in processing efficiency for the system 100.

Parallel Processing of Plural Regions of the Image of Contents of the Receptacle 104

As described above, in this embodiment, in cases where the processing system 120 identifies a plurality of regions of interest of the image of contents of the receptacle 104, the processing system 120 is adapted to process in parallel these plural regions of interest in order to determine if any of these regions of interest depicts a threat-posing object.

It will be appreciated that, in other embodiments, the parallel processing architecture implemented by the processing system 120 can be applied to process in parallel any plurality of regions of the image of contents of the receptacle 104, and not just plural regions of interest of the image, in order to determine if the image depicts a threat-posing object. That is, the parallel processing capability of the processing system 120 is not limited to being used for processing in parallel a plurality of regions of interest of the image of contents of the receptacle 104.

For example, in some embodiments, the processing system 120 may process in parallel a plurality of regions of the image of contents of the receptacle 104, where each region is a sub-region of a region of interest of the image that has been identified by the processing system 120. In other embodiments, the processing system 120 may not be designed to identify regions of interest of the image of contents of the receptacle 104 (e.g., the region of interest locator module 804 may be omitted). In such embodiments, the processing system 120 may process in parallel a plurality of regions of the image, where each region is a portion (e.g., a rectangular portion) of the image. Thus, in various embodiments, the processing entities 180₁-180_{M} may effect a plurality of parallel processing threads, where each processing thread processes image data from plural regions of the image of contents of the receptacle 102 (which may or may not be regions of interest of the image).

Parallel Processing of Plural Regions of the Image of Contents of the Receptacle 102 Concurrently with Parallel Processing of Different Sets of Entries in the Reference Database 110

It will be appreciated that, in some embodiments, the parallel processing architecture may enable the processing system 120 to concurrently effect parallel processing of plural regions of the image of contents of the receptacle 102 (which may or may not be regions of interest of the image) and parallel processing of different sets of entries in the reference database 110, thereby resulting in further processing efficiency for the system 100.

Screening of Persons

Although the above-described system 100 was described in connection with screening of receptacles, principles described above can also be applied to screening of people.

For example, in an alternative embodiment, a system for screening people may be provided. The system includes components similar to those described in connection with the system 100 above. In such an embodiment, an image generation apparatus similar to the image generation apparatus 102 may be configured to scan a person, possibly along various axes and/or views, to generate one or more images of the person. The one or more image are indicative of objects carried by the person. Each image is then processed in accordance with methods described herein in an attempt to detect one or more prohibited or other threat-posing objects which may be carried by the person.

Physical Implementation

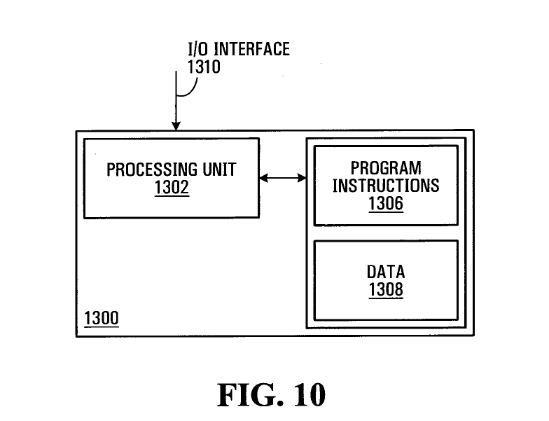

In some embodiments, certain portions of components described herein may be implemented on a general-purpose digital computer 1300, of the type depicted in FIG. 10, including a processing unit 1302 and a memory 1304 connected by a communication bus. The memory includes data 1308 and program instructions 1306. The processing unit 1302 is adapted to process the data 1308 and the program instructions 1306 in order to implement functionality of the certain portions of components described herein. The digital computer 1300 may also comprise an I/O interface 1310 for receiving or sending data elements to external devices.

In other embodiments, certain portions of components described herein may be implemented on a dedicated hardware platform implementing functionality of these certain portions. Specific implementations may be realized using ICs, ASICs, DSPs, FPGAs, an optical correlator, a digital correlator or other suitable hardware platform.

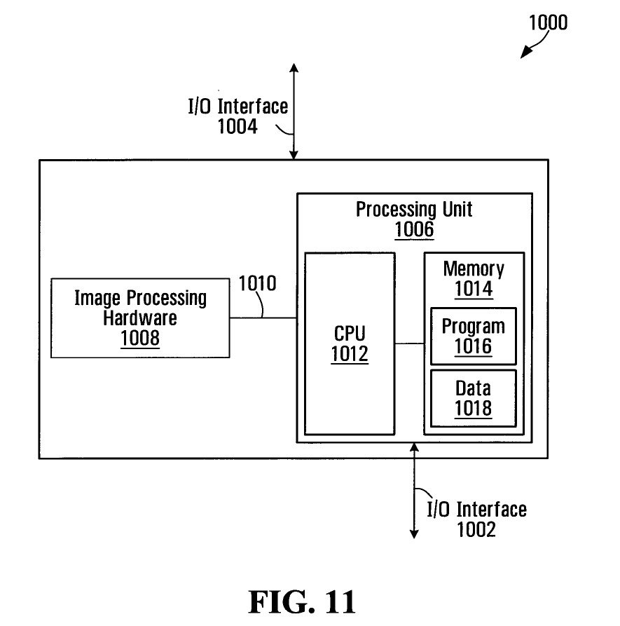

In yet other embodiments, certain portions of components described herein may be implemented as a combination of dedicated hardware and software such as apparatus 1000 of the type depicted in FIG. 11. As shown, such an implementation comprises a dedicated image processing hardware module 1008 and a general purpose computing unit 1006 including a CPU 1012 and a memory 1014 connected by a communication bus. The memory includes data 1018 and program instructions 1016. The CPU 1012 is adapted to process the data 1018 and the program instructions 1016 in order to implement the functional blocks described in the specification and depicted in the drawings. The CPU 1012 is also adapted to exchange data with the dedicated image processing hardware module 1008 over communication link 1010 to make use of the image processing capabilities of the dedicated image processing hardware module 1008. The apparatus 1000 may also comprise I/O interfaces 1002 1004 for receiving or sending data elements to external devices.

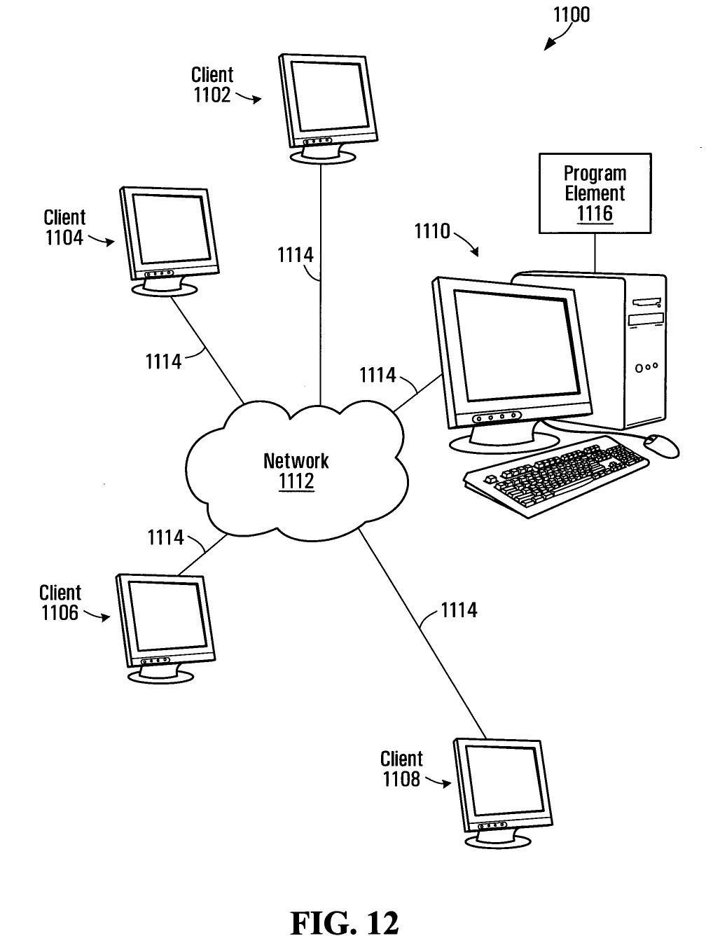

It will be appreciated that the system 100 (depicted in FIG. 1) may also be of a distributed nature where images of contents of receptacles are obtained at one or more locations and transmitted over a network to a server unit implementing functionality of the processing system 120 described above. The server unit may then transmit a signal for causing a display unit to display information to a user. The display unit may be located in the same location where the images of contents of receptacles were obtained or in the same location as the server unit or in yet another location. In one implementation, the display unit is part of a centralized screening facility. FIG. 12 illustrates a network-based client-server system 1100 for system for screening receptacles. The client-server system 1100 includes a plurality of client systems 1102, 1104, 1106 and 1108 connected to a server system 1110 through network 1112. The communication links 1114 between the client systems 1102, 1104, 1106 and 1108 and the server system 1110 can be metallic conductors, optical fibers or wireless, without departing from the spirit of the invention. The network 1112 may be any suitable network including but not limited to a global public network such as the Internet, a private network, and/or a wireless network. The server 1110 may be adapted to process and issue signals concurrently using suitable methods known in the computer related arts.

The server system 1110 includes a program element 1116 for execution by a CPU. Program element 1116 includes functionality to implement the functionality of apparatus 120 (shown in FIGS. 1 and 2) described above, including functionality for displaying information associated to a receptacle and for facilitating visual identification of a threat in an image during security screening. Program element 1116 also includes the necessary networking functionality to allow the server system 1110 to communicate with the client systems 1102, 1104, 1106 and 1108 over network 1112. In a specific implementation, the client systems 1102, 1104, 1106 and 1108 include display devices responsive to signals received from the server system 1110 for displaying a user interface module implemented by the server system 1110.

Although various embodiments of the present invention have been described and illustrated, it will be apparent to those skilled in the art that numerous modifications and variations can be made without departing from the scope of the invention, which is defined in the appended claims.

1.-8. (canceled)

9. A security screening system comprising:
an input for receiving image data derived from an apparatus that subjects items to penetrating radiation, the image data conveying an image of the items;
a processing module for processing the image data to identify in the image a plurality of regions of interest, the regions of interest manifesting a higher probability of depicting a security threat than portions of the image outside the regions of interest, said processing module being for:
processing a first one of the regions of interest to ascertain if the first region of interest contains a security threat; and
processing a second one of the regions of interest to ascertain if the second region of interest contains a security threat,
wherein the processing of the first and second regions of interest occurs in parallel.

10. A security screening system to determine if an item of luggage carries a security threat, said security screening system comprising:
an input for receiving image data derived from an apparatus that subjects the item of luggage to penetrating radiation, the image data conveying an image of the item of luggage;
a processing module for processing the image data to identify in the image a plurality of regions of interest, the regions of interest manifesting a higher probability of depicting a security threat than portions of the image outside the regions of interest, said processing module comprising:
a first processing entity for processing a first one of the regions of interest to ascertain if the first region of interest depicts a security threat; and
a second processing entity for processing a second one of the regions of interest to ascertain if the second region of interest depicts a security threat, wherein the processing of the first and second regions of interest by the first and second processing entities occurs in parallel.

11. A security screening system as defined in claim 10, wherein the penetrating radiation is X-rays.

12. A security screening system as defined in claim 11, wherein the image data conveys a two dimensional X-ray image of the item of luggage.

13. A security screening system as defined in claim 12, comprising a display unit to display an image of the item of luggage derived from the image data in which the regions of interest are highlighted.

14. A security screening system as defined in claim 13, wherein said processing module is programmed for displaying on the display unit the image of the item of luggage derived from the image data in which the regions of interest are highlighted while processing the regions of interest in the image to ascertain if the regions of interest depict a security threat.

15. A security screening system as defined in claim 10, wherein the regions of interest in the image are derived substantially based on information intrinsic to the image of the item of luggage.

16. A security screening system as defined in claim 10, wherein said processing module is programmed for deriving information conveying a level of confidence that the item of luggage contains a security threat.

17. A security screening system as defined in claim 10, said security screening system further comprising:
a database containing a plurality of entries, each entry including a representation of an object posing a security threat;
wherein processing the first one of the regions of interest to ascertain if the first region of interest depicts an object posing a security threat comprises:
processing the first one of the regions of interest against a first set of entries from the database to determine if the first one of the regions of interest depicts an object posing a security threat represented by any entry of the first set of entries; and
processing the first one of the regions of interest against a second set of entries from the database to determine if the first one of the regions of interest depicts an object posing a security threat represented by any entry of the second set of entries,
wherein the first set of entries is different from the second set of entries and the processing of the first one of the regions of interest against the first and second set of entries occurs in parallel.

18. A method for performing security screening comprising:
subjecting items to penetrating radiation to generate image data that conveys an image of the items;
processing the image data to identify a plurality of regions of interest within the image that manifest a higher probability of depicting a security threat than portions of the image outside the regions of interest; and
initiating a plurality of parallel software processing threads, each processing thread processing image data from a respective region of interest, wherein each processing thread searches the image data it processes to ascertain if it depicts a security threat.

19. A method for performing security screening on an item of luggage, said method comprising:
subjecting the item of luggage to penetrating radiation to generate image data that conveys an image of the item of luggage;
processing the image data to identify a plurality of regions of interest within the image that manifest a higher probability of depicting a security threat than regions outside the regions of interest; and
initiating a plurality of parallel software processing threads, each software processing thread processing image data from the regions of interest, wherein each software processing thread searches the image data it processes to ascertain if it depicts a security threat.

20. A method as defined in claim 19, wherein the penetrating radiation is X-rays.

21. A method as defined in claim 20, wherein the image data conveys a two dimensional X-ray image of the item of luggage.

22. A method as defined in claim 21, said method comprising displaying an image of the item of luggage derived from the image data in which the regions of interest are highlighted.

23. A method as defined in claim 22, said method comprising displaying the image of the item of luggage in which the regions of interest are highlighted while processing the regions of interest in the image to ascertain if the regions of interest depict a security threat.

24. A method as defined in claim 19, said method comprising identifying the regions of interest substantially based on information intrinsic to the image data.

25. A method as defined in claim 19, said method comprising deriving information conveying a level of confidence that the item of luggage contains a security threat.

26. A method as defined in claim 19, said method comprising:
providing a database containing a plurality of entries, each entry including a representation of an object posing a security threat;
processing a first one of the regions of interest against a first set of entries from the database to determine if the first one of the regions of interest depicts an object posing a security threat represented by any entry of the first set of entries; and
processing the first one of the regions of interest against a second set of entries from the database to determine if the first one of the regions of interest depicts an object posing a security threat represented by any entry of the second set of entries,
wherein the first set of entries is different from the second set of entries and the processing of the first one of the regions of interest against the first and second set of entries occurs in parallel.

27. A security screening system comprising:
an input for receiving image data derived from an apparatus that subjects items penetrating radiation;
a database containing a plurality of entries, each entry including information associated with a security threat;
a processing module for processing the image data to determine if the image depicts a security threat from the database, said processing module being for:
processing image data against a first set of entries from the database to determine if the image data contains a security threat represented by any entry of the first set of entries; and
processing image data against a second set of entries from the database to determine if the image data contains a security threat represented by any entry of the second set of entries,
wherein the first set of entries is different from the second set of entries and the processing of the image data against the first set of entries and the second set of entries occurs in parallel.

28. A security screening system to determine if an item of luggage carries a security threat, said security screening system comprising:
an input for receiving image data derived from an apparatus that subjects the item of luggage to penetrating radiation, the image data conveying an image of the item of luggage;
a database containing a plurality of entries, each entry including a representation of a security threat;
a processing module for processing the image data to determine if the image of the item of luggage depicts a security threat from the database, said processing module including:
a first processing entity for processing image data against a first set of entries from the database to determine if the image data depicts a security threat represented by any entry of the first set of entries; and
a second processing entity for processing image data against a second set of entries from the database to determine if the image data depicts a security threat represented by any entry of the second set of entries,
wherein the first set of entries is different from the second set of entries and the processing by the first and second processing entities occurs in parallel.

29. A security screening system as defined in claim 28, wherein the penetrating radiation is X-rays.

30. A security screening system as defined in claim 29, wherein the image data conveys a two dimensional X-ray image of the item of luggage.

31. A security screening system as defined in claim 28, wherein the processing module is programmed for processing the image data to identify in the image a plurality of regions of interest, the regions of interest manifesting a higher probability of depicting a security threat than portions of the image outside the regions of interest.

32. A security screening system as defined in claim 31, comprising a display unit to display an image of the item of luggage derived from the image data in which the regions of interest are highlighted.

33. A security screening system as defined in claim 32, wherein said processing module is programmed for displaying on the display unit the image of the item of luggage derived from the image data in which the regions of interest are highlighted while processing the regions of interest in the image to ascertain if the regions of interest depict a security threat.

34. A security screening system as defined in claim 28, wherein said processing module is programmed for deriving information conveying a level of confidence that the item of luggage contains a security threat.

35. A method for performing security screening comprising:
receiving image data derived from an apparatus that subjects items to penetrating radiation;
providing access to a database containing a plurality of entries, each entry including information related to a security threat;
processing image data against a first set of entries from the database to determine if the image data contains a security threat represented by any entry of the first set of entries; and
processing image data against a second set of entries from the database to determine if the image data contains a security threat represented by any entry of the second set of entries;
wherein the first set of entries is different from the second set of entries and said processing of the image data against the first and second set of entries occurs in parallel.

36. A method for performing security screening on an item of luggage, said method comprising:
receiving image data derived from an apparatus that subjects the item of luggage to penetrating radiation, the image data conveying an image of the item of luggage;
providing access to a database containing a plurality of entries, each entry including a representation of a security threat;
processing image data against a first set of entries from the database to determine if the image data depicts a security threat represented by any entry of the first set of entries; and
processing image data against a second set of entries from the database to determine if the image data depicts a security threat represented by any entry of the second set of entries;
wherein the first set of entries is different from the second set of entries and said processing of the image data against the first and second set of entries occurs in parallel.

37. A method as defined in claim 36, wherein the penetrating radiation is X-rays.

38. A method as defined in claim 37, wherein the image data conveys a two dimensional X-ray image of the item of luggage.

39. A method as defined in claim 36, comprising processing the image data to identify in the image a plurality of regions of interest, the regions of interest manifesting a higher probability of depicting a security threat than portions of the image outside the regions of interest.

40. A method as defined in claim 39, comprising displaying an image of the item of luggage derived from the image data in which the regions of interest are highlighted.

41. A method as defined in claim 40, comprising displaying the image of the item of luggage derived from the image data in which the regions of interest are highlighted while processing the regions of interest in the image to ascertain if the regions of interest depict a security threat.

42. A method as defined in claim 36, comprising deriving information conveying a level of confidence that the item of luggage contains a security threat.
